(19) United States
(12) Patent Application Publication
(10) Pub. No.: US 2025/0388399 A1
(43) Pub. Date: Dec. 25, 2025

(54) CASE MANIPULATOR SYSTEM AND METHOD OF USING THE SAME

(71) Applicant: Ocado Innovation Limited, Hatfield (GB)

(72) Inventors: Benjamin Arthur Portnoy NOAR, London (GB); Matthew William NORTH, Redhill (GB); William James COGLEY, Hertfordshire (GB); Ian PARKS, St Albans (GB)

(21) Appl. No.: 19/308,138

(22) Filed: Aug. 22, 2025

Related U.S. Application Data
(63) Continuation of application No. PCT/EP2024/054395, filed on Feb. 21, 2024.

(30) Foreign Application Priority Data
Feb. 23, 2023 (GB) 2302634.7
Mar. 8, 2023 (GB) G2303404.4
Jul. 17, 2023 (GB) 2310930.9

(51) Int. Cl. B65G 1/137; B25J 9/00; B25J 15/02; B65B 5/04; B65B 35/16; B65B 69/00

(52) U.S. Cl. CPC B65G 1/137; B25J 9/0093; B25J 15/0253; B65B 5/04; B65B 35/16; B65B 69/00

(57) ABSTRACT

A case manipulator system and a method for using the same. A case manipulator system, comprising: a first location of a case; a second location, the second location comprising a guiding means for guiding the case into or out of a container; and a case manipulator comprising a moveable support movable from a first position above the first location to a second position above the second location, and a paddle assembly having at least a first pair of paddles, the paddle assembly arranged to move the at least first pair of paddles relative to the moveable support, the case manipulator system arranged such that: a case in the first location is accessible by the case manipulator, the case manipulator system controllable to engage with the case and move the case from the first location to the second location, and insert the case into a container at the second location.

### CROSS-REFERENCE TO RELATED APPLICATIONS

This Application is a continuation of PCT International Patent Application No. PCT/EP2024/054395, filed on Feb. 21, 2024, which claims priority UK Patent Application No. GB2310930.9, filed on Jul. 17, 2023, which claims priority to UK Patent Application No. GB2303404.4, filed on Mar. 8, 2023, which claims priority to UK Patent Application No. GB2302634.7, filed on Feb. 23, 2023, the entire contents of each of which are hereby incorporated by reference.

### FIELD

The present disclosure concerns a case manipulator system for placing cases into a container or for removing cases from a container. The case manipulator system may be used in an automated storage and retrieval system (ASRS). More particularly, the case manipulator system may be used for automating inbound activities, for storing and sorting cases of inventory, and other warehouse operations.

### BACKGROUND

EP 1037828 B1 (Autostore) describes a system in which stacks of containers are arranged within a frame structure. Robotic load handling devices can be controllably moved around the stack on a system of tracks on the uppermost surface of the stack.

A load handling device is described in UK Patent Application No. GB2520104A (Ocado Innovation Limited) where each robotic load handler only covers one grid space, thus allowing high density of load handlers and thus high throughput of a given size system.

In other arrangements, the robotic load hander may have a cantilever arrangement with the weight of the body of the bot counterbalancing the weight of the container to be lifted.

In the known robotic picking systems described above, robotic load handling devices are controllably moved around the top of the stacks on a track system forming a grid. A given load handling device lifts a bin (container) from the stack, the (storage) container (ST) being lifted containing inventory items needed to fulfil a customer order. The container (ST) is carried to a pick station where the required inventory item may be manually removed from the bin (ST) and placed in a delivery container (DT), the delivery container forming part of the customer order, and being manually filled for dispatch at the appropriate time. At the pick station, the items may also be picked by industrial robots, suitable for such work, for example as described in UK Patent Application No GB2524383B—Ocado Innovation Limited.

WO2014/203126 A1 (Ocado Innovation Limited) describes a system for order processing, in particular method of storage and retrieval of storage and delivery containers in order processing systems. In this system, efficiencies may be realized by storing one or more delivery containers within storage containers, and storing such combined container sets within the storage and retrieval grid, racking or other ordered arrangement, along with storage containers containing items to be used in filling customer orders.

In the known robotic picking systems described above, various aspects of storage and retrieval systems have been automated. However, today warehouses still use personnel to carry out certain tasks that are difficult to automate. Inbound activities have been particularly difficult to automate due to the variety of products, and due to the different types of packaging that they are arriving in.

Reusable and/or collapsible cases or boxes represent a particular challenge for automation, where boxes or cases are stored in containers. At inbound, the cases must be placed into a container to be inducted into the ASRS. Typically, a reusable and/or collapsible cardboard box or case may be formed from a flat piece of cardboard. The cardboard is folded into a rectangular tube, and secured along the join. Each end of the tube is divided along the folded edges to form a flap on each side of the case. The flaps are then folded towards the center of the tube to form the top and bottom of the case. For the bottom of the case, the flaps are typically arranged to meet and may be temporarily secured with a fan fold, or more lastingly secured with the addition of tape, glue, staples or any other suitable means. For the top of the case, the flaps may or may not meet, and the case may be closed with a simple fold, a fan fold or left open, or the top may be more lastingly secured, similarly to the bottom. Alternatively, boxes or cases may be made from relatively thin, foldable plastic or other types of suitable materials. In order to reduce waste, it is desired that a single case may be reused 5-10 times, or even more times.

There are some issues associated handling boxes or cases of this type. Such cases are flimsy and therefore are easily damaged or deformed. Firstly, cases may be damaged before they arrive. Secondly, cases may be damaged by robotic manipulators. Thirdly, cases may lack structural integrity. Fourthly, cases may be inconsistently presented open, closed or partially open. Fifthly, cases may be deformed before they arrive. Sixthly, cases may be deformed by robotic manipulators. Additionally, it will be appreciated that cases that are closed without additional securing means will be less structurally stable.

Further, cases may be full, partially filled or empty. Full cases may have different handling characteristics compared with partially filled or empty cases. It will be appreciated that full cases may be completely full when no additional items/SKUs may be carried in the case, however, the case may have a volume of unfilled space.

It is against this background that the invention has been devised.

It will be appreciated that while the devices, apparatus, system and methods described herein are described in the context of grocery systems as an example of background art, automated or semi-automated storage and retrieval systems (ASRS) are not limited to systems directed to groceries. For example, the technology can be applied to shipping, baggage handling, vehicle parking, indoor or hydroponic greenhouses and farming, modular buildings, self-storage facilities, cargo handling, transport switchyards, manufacturing facilities, pallet handling, parcel sortation, airport logistics (ULD) and general logistics to name but a few possible applications. It will be appreciated that storage and retrieval systems of different types may have different technical requirements, however the principals remain similar.

### SUMMARY

Aspects of the invention are set out in the accompanying claims.

In a first aspect, there is a case manipulator system for use in an automated storage and retrieval system, the case manipulator system comprising: a first location for one or more cases; a second location, wherein the second location comprises a guiding means for guiding cases into and/or out from a container; and a case manipulator comprising a moveable support, movable from a first position above the first location to a second position above the second location, and a paddle assembly having at least a first pair of paddles, and the paddle assembly is arranged to move the at least first pair of paddles relative to the movable support, in a first horizontal (x-)direction, and in a vertical (z-)direction, wherein the case manipulator system is arranged such that: a case in the first location is accessible by the case manipulator, and the case manipulator system is controllable to engage with the case and move the case from the first location to a second location, and at the second location, insert the case into a container at the second location; and/or a case in a container in the second location is accessible by the box manipulator, and the case manipulator is controllable to remove the case from the container and place the case at the first location.

The case manipulator system is suitable for handling any type of folded box or case, specifically; the case manipulator system is suitable for handling both cardboard, plastic and other types of materials. The case manipulator system may interface with other systems, such as an ASRS similar to the types of ASRS described above, and may be used as ‘periphery’ or sub-subsystem in particular, but not limited to inbound operations.

An inbound case may be introduced or inducted into the ASRS system using the case manipulation system, for storage in containers or totes. Cases or boxes to be inducted are located in the proximity of the manipulator system. Cases may be full, partially filled or open. Cases may be fully open, with the flaps directed substantially outwards or upwards, partially open with the flaps at least partially covering the top of the case, closed with the flaps arranged in a fan fold, or closed with the flaps secured with glue or tape, as described above.

The case manipulator system has an area beneath a case manipulator for receiving cases (a first location) and a second area (a second location) for putting cases into containers.

The case manipulator has a movable support. The movable support may be an arm, a 6-axis robot, a tack, a rail, a gantry frame, a floor mounted support, or any means suitable for linear motion between a position above the first location and the second location.

A paddle assembly is connected to the movable support. The paddle assembly is used for engaging with a target case to move the case from the first location to the second location. Each of the paddles of the paddle assembly are arranged to move in either x- and or y-directions, and vertically in the z-direction. Cases may be only marginally smaller than the containers, and therefore difficult to insert into containers. In some instances, cases may be tighter in one direction relative to the second dimension. Accurately and or exactly positioning the container, and or case may be necessary for enabling insertion or placement a target case in a container. Accordingly, guiding means is provided at the second location.

Guiding means may be used to exactly position a container, and or guiding means may be used to direct the case as the case moves towards the container.

It will be appreciated that different guiding means may be required where the case manipulator is used to remove a case from a container.

Guiding means may be mechanical and/or guiding means may be in the form of a control system having vison and or sensor inputs, and or control feedback.

The selected guiding means may have various advantages.

It will be understood that the case manipulator may be controllable to engage with one or more flaps of a case, to fold the one or more flaps, and/or the case manipulator may be controllable to grip opposing sides of the case to lift the case.

The paddles are controlled to manipulate or engage the flaps of a case, and or in the case of a closed case, to clamp a case in order to lift and relocate the case. The paddles work in pair(s), on opposed sides of the case. The movement of a pair of paddles may be symmetrically mirrored, or the movement may be asymmetrical to account for the arrangement of the case, and in particular an asymmetric arrangement of the flaps of the case. A first pair of paddles may work independently to a second pair of paddles; the first and second pair of paddles may work in parallel (i.e. concurrently) or sequentially.

With a case in the first location, a distal end of the paddles (i.e. distal from the support) is inserted, substantially centrally, between the flaps.

A first type of paddle may then be controlled to move following a substantially inverted question mark-shaped (“?”) pathway. It will be appreciated that the motion may be smooth and/or continuous, or the motion may be a series of vertical horizontal x- or y-direction movements. In this way, the paddles are able to move to fully open the flaps and fold them outwardly and downwards, such that the resultant position of the flaps is substantially parallel with the sides of the case, leaving the case open with a folded upper edge.

The paddles then move to locate with the folded and now upper edge of the case.

Once the case is open with a folded upper edge and the paddles are located with the upper edge, the paddles move inwards, towards the center of the case, to slightly compress the case. Thereby clamping or gripping the case to enable lifting of the case. The case may then be raised or lifted, and the movable support may move the paddle assembly and consequently the case from the first location to above the second location.

Finally, the case may be inserted into a container, and the paddles are released from the case.

Alternatively, where a case is to be stored closed, the paddles may be moved to locate with the upper edge of the case, and move inwards, towards the center of the case, to slightly compress the case and clamp or grip the case to enable lifting of the case (without opening and folding the flaps). The case may then be raised or lifted, and the movable support may move the paddle assembly and consequently the case from the first location to above the second location.

The paddles are arranged to interact with the case substantially at the top of the body of the case, and in substantially the middle of the sides. It will be appreciated that when cases are reused, the flaps are likely to be damaged. Further, in order to maintain structural integrity of the case, it is preferable to avoid interacting with the corners where the case is more likely to be crushed and or deform if pressure is put on them. Accordingly, the paddles are directed to parts of the case which are likely to be least damaged, and to the part(s) of the case that are least likely to be damaged by interaction with the case manipulator, so that cases may be reused. For other instances, it may be preferable for the paddles to interact with the corners, so avoid flexing the case sides as the case is manipulated.

The first location may comprise a first conveyor, and the first conveyor may present cases to the case manipulator.

Cases may be presented to the pick-up location (first location) by a conveyor. In this way, a continual stream of cases may be presented to the case manipulator system to ensure that the manipulator system operates efficiently.

The first conveyor may comprise an indexing means. An indexing device may be used on the first conveyor to ensure that the cases are sufficiently spaced to allow time and space for the flaps of each case to be fully opened, and folded down to be parallel with the sides of the case.

Optionally, a vision and control system may be positioned to view cases upstream of the case manipulator, in order to inspect cases prior to being presented to the case manipulator. Cases which do not pass the inspection may be diverted. For example, where a case is too damaged to be successfully moved from the first location to the second location by the case manipulator, the case may be diverted.

Optionally, a case opener device may be positioned to operate on cases upstream of the case manipulator, in order to enable cases which are sealed shut to be opened by the case manipulator. For example, where cases are taped closed, a knife or blade device may be used to cut the tape to ensure the case flaps are free to move. Any other suitable means may be used to open cases, depending on how the cases are typically sealed.

Optionally, an urging means at or prior to the first location may be provided to ensure that a target case arrives in the expected position at the first location. For example, the urging means may comprise guiding rails that sit along the conveyor, or the urging means may comprise a centralizing mechanism or tool and opposing fixed stop bar, to push a case into a central position on the conveyor so that the case is in an expected position within the first location. In some arrangements, the case may be clamped between the urging means and the stop bar while other operations are performed. For example, the case may be clamped while in the first location while the case flaps are opened.

The second location may comprise a second conveyor, and the second conveyor may present containers under the guiding means. Alternatively, the guiding means may be located within each container.

A second conveyor may be used at the second location to ensure a continual stream of containers are available to the case manipulator system, for receiving cases and to ensure that the manipulator system operates efficiently.

The second conveyor may be coordinated with the first conveyor to deliver containers at the same rate that the first conveyor delivers cases. It will be appreciated that the second conveyor may not require an indexing device as there is no specific requirement for there to be space between the containers.

Further, the second conveyor or a third conveyor may be used to remove combined container and cases from the case manipulator system, and move the combined container and cases into a storage or sortation system. Or in reverse, the second conveyor or a third conveyor may be used to deliver combined container and cases from the storage or sortation system for the case manipulator system to remove the case from the container.

The paddle assembly may comprise a second pair of paddles, and may be arranged to move the second pair of paddles, in a second horizontal (y-)direction, and in a (z-)vertical direction. The first pair of paddles and the second pair of paddles may be independently operable. Each paddle may be independently operable.

Typically, cases have flaps on each side, and therefore, it may be necessary to ensure that the case flaps can be folded and held on all sides of the case. Accordingly, a first pair or first horizontal (x-)direction paddles and a second pair or second horizontal (y-)direction paddles may be provided. Alternatively, one of the first or second pair of paddles may be replaced with a single paddle.

As the requirements on the x-side or the y-side of the target case are likely to be different, thus the paddles may be arranged to each operate cooperatively but independently, either in pairs or individually. For example, in a first direction, given relative dimensions between the case and the container, it may be possible to insert the case into a container while the paddles are still clamped to the case. While in the second direction, the fit between the case and the container may be too tight for the case to be inserted with the paddles. In some examples, the case may be slightly larger in dimension compared with the container and therefore require a squeeze or compression in one direction in order to fit into the container.

It will be appreciated that the paddles for engaging with each side of the case may be sized proportionally with the intended cases. In some examples, the paddles may be relatively wide to engage with a large proportion of a case. In other examples, more than one paddle, operating together or separately, may be arranged to engage with each side, OR paddles may be segmented.

In an alternative arrangement, the x-side operations and the y-side operations may be separated to occur at subsequent locations on the conveyor. Thus, the case manipulator system may comprise a first case manipulator and a second case manipulator. The second case manipulator may be arranged downstream of the first case manipulator, and rotated by approximately 90° about a z-axis relative to the orientation of the first case manipulator. In this way, each case manipulator may be simplified.

The second location may comprise one or more guides, for guiding containers into position in the second location. It will be appreciated that different guides may be required for operating the apparatus in reverse i.e. where it is intended that a case is removed from a container using the apparatus. Guides for removing a case from a container may be necessary where a case has shifted position within a container. Such a situation may arise where a case is smaller than the container it is placed within. As a result, a case may require guides to center the case before the manipulator may remove it.

As noted above, the guiding means may be mechanical or electrical. Further, mechanical guiding means may be static or dynamic.

In some embodiments, a guide may comprise a frame over or around the second conveyor which a container must pass, in order to ensure correct alignment in a first direction. In a second direction, correct alignment may be ensured by a stop flap.

Further, guiding means may comprise a funnel, to direct the case into a container located beneath. In this example, the container is positioned below the funnel. The guiding means may also be used to ensure that the flaps are kept parallel with the sides as the case is put into the container.

The guiding means may be a stationary funnel OR the guiding means may be a retractable locator. The guiding means may comprise guides on two or more sides of a case. The guiding means may comprise guides on three sides of a case. The leading edge of the guiding means may be shaped to assist in inserting a case into position.

A funnel may be used as guiding means, to guide cases into containers. The funnel may be suitably shaped to ensure that the flaps remain tightly aligned with the sides of the case as the manipulator lowers the case into the container. When the case flaps are held by the funnel, the pair of paddles on the corresponding sides may be released. The funnel may squeeze one dimension of the case to assist in inserting the case where the external dimension of the case is very close to the internal dimension of the container. Further, the funnel may assist in centering the case relative to the container.

In an alternative arrangement, the case may be held in position while a container is pushed upwards on to the case.

A dynamic locator may be used to verify the position of the container in the second location. For example, a retractable locator, may be a torpedo locator and a type of dynamic locator. A torpedo may be a guide member with elongate shape. The container or tote may have features in the top edge that are able to mate or engage a torpedo, or a torpedo may locate to the corners of the tote. The torpedo locator may have a torpedo located on a frame at each corner and may be positioned above the second location. The torpedo locator may extend or lower to exactly locate or confirm position of the tote in the location. The torpedo locator may then retract, once the tote is confirmed to be in the correct location. The torpedo locator may have fewer than four guide members, depending on the shape of the frame.

The paddles may have an inverted L-shape. One or more of the paddles may comprise a hooked distal end. One or more of the paddles may comprise a gripping means. The horizontal portion of an ‘L’ may be directed towards the center of the paddle assembly. In this way, the horizontal portion of a paddle may be used to locate the paddle on the upper edge of the case, while the vertical portion of the paddle may be used to apply pressures to the sides of the case.

Where flaps are tightly closed or fan folded, it may be useful to provide a hook at the distal end of the vertical portion of the ‘L’ to assist in making an opening between the flaps to properly insert the paddles. This may be particularly useful where the flaps are fan folded. Other means may be necessary to open closed fan folded flaps, for example, inserting an expandable device such as an inflatable that pushes the flaps open when expanded.

The paddles may further be provided with features to enhance grip between the vertical portion of the paddle and the sides of the cases. For example, rubber or gecko skin type materials applied to the contact surface of the paddle may increase friction. A suction device may provide an attraction between the paddle and the case. Alternatively, or additionally, an array of spaced apart pins may protrude from the paddle surface. These may puncture the surface of the side of the case to secure the hold on the case.

Gripping means may comprise using force feedback or haptics to improve grip control of the paddles. For example, this may be particularly useful when lifting cases out of containers.

Other means to improve operation of the paddles will be apparent to the skilled person. For example, a potentially suitable pincer-type end effector or paddle gripper for lifting open top carriers (boxes or cases) is disclosed in PCT/EP2023/055783 (Ocado Innovation Limited). In another arrangement, the paddles may be provided with a clamp that may be actuated to clamp the sides of an open case.

Alternatively, a second type of paddle may be shaped to correspond to the shape of the corners of a case and therefore support the corners of a case. With such paddles, the case manipulator may be directed to interact with the corners, rather than the sides. In this situation, for example, the manipulator may be rotated approximately 45° about a z-axis.

A third type of paddle or end effector may be arranged to extend beyond the bottom of a case, to support the case from underneath. The paddle support may comprise one or more swivel fork(s) at the distal end of the paddle, where the swivel fork(s) are movable between a first position substantially parallel with the side of a case, and a second position substantially perpendicular to the side of a case and extending in a direction under a case. With the swivel fork(s) in the first position, the distal end of the paddle may be used to open the flaps of a case. With the swivel fork(s) in the second position and the paddle moved to the bottom of the case, the paddle may be used to lift and move the case.

Optionally, to assist in using the third type of paddle to remove cases from containers, the distal end may be wedge shaped, for inserting between the side of a case and the side of a container. The wedge may extend below the swivel fork(s).

The wedge may be movably mounted at the distal end of the paddle such that the wedge may be pushed up into the paddle arm. In this way, when the paddle is pushed to the bottom of a container, the wedge retracts into the arm, and the swivel fork(s) may reach substantially the bottom of the container. The swivel forks(s) may then be rotated perpendicular to the case to enable lifting of the case. The wedge may be spring biased to an extended position.

Optionally, the third type of paddle may comprise a top plate, to locate with the top of a case.

In this way, the third type of paddle may be used to open the flaps of a case, lift the case from a first location to a second location, push the case into a container, and extract the case from the container.

In some embodiments, paddles, such as the third type of paddle, may be combined with other tools, for example, gripper wedges to assist in inserting cases inside containers and ensure that the container is centralized within the container. Gripper wedges may comprise surface features to improve their grip on cases, for example.

A fourth type of paddle or end effector may be used to open a case, and fold down the flaps. The fourth end effector may comprise an arm with a hook end or claw. The case manipulator, having a fourth type end effector, may be mounted beside the first location, and movable in y- (or x-) and z-directions. Where a case is closed with a fan fold, the claw is inserted between the flaps, hooks over the edge of the flap, and pulls the flap open. It will be appreciated that due to the fan fold arrangement, an orthogonal flap opens with the hooked flap. A pair of arms having claw end effectors or fourth type paddles, operating on opposing sides of a case, may work together to open all the flaps of a fan folded case.

The case manipulator may comprise two pairs of opposing paddles, having a combination of paddle types. For example, the first or third paddle type may comprise a first pair of paddles, and a second pair of paddles arranged orthogonally to the first pair of paddles may comprise the fourth paddle type.

It will be appreciated that other types of paddles and end effectors may operate similarly to the specific ones described here.

The case manipulator system may comprise a control utility to control operation.

In a second aspect, there is a method of using a case manipulator system according to any of the first aspects, to move a case from the first location and place the case into a container at the second location and/or remove a case from a container at a second location and place the case at the first location, wherein the case is moved from the first location and placed into the container at the second location by: controlling the paddle assembly to lower the first pair of paddles to be positioned between a pair of case flaps, when the case manipulator is in a first position; moving the first pair of paddles, to engage with the pair of case flaps (outward in x-direction), push or pull the case flaps outwards (outward in x-direction), fold the case flaps over (downwards in z-direction), to be arranged folded down on the outside of the case, locate the first pair of paddles at opposing folded top edges of case, or opposing sides of the case (downwards in z-direction, and inwards in x-direction), and clamp the case between the first or second pair of paddles (inwards in x-direction); moving the movable support from the first position to the second position, while clamping the case with a pair of paddles; locating the case within the guiding means at the second location; releasing the case; and inserting the case into a container at the second location; and/or wherein the case is removed from the container at the second location and placed at the first location by operating steps a. to f. in reverse.

The motion of the paddles may resemble an inverted question mark (?) motion. At least one of steps a.-f. may be performed in the y-direction and the z-direction by a second pair paddles, to engage with each side of the case.

As noted above, typically a case will have flaps on each side of the top opening. Accordingly, a second pair of paddles may be used to manipulate each of the flaps. The second pair of paddles may not be required to perform all of the steps. For example, in the case of a funnel guide, where the flaps are held in the folded position by the funnel, the second pair of paddles may be released before the first set of paddles.

After step d. and before step e., at least one pair of paddles may be used to move the case vertically.

Where guiding means is mechanical, the paddles may be used to push the case into position, for example. In the example of a funnel guide, where the funnel narrows to be slightly narrower than the case then additional force may be required for the case to move through the guide to be inserted into the container.

Alternatively, it will be appreciated that the container may be pushed up on to the case instead of the case being pushed into the container.

The first conveyor may be used to present a case to or receive a case from the case manipulator.

As noted above, it may be advantageous to continually feed cases and or containers to the case manipulator system.

The second conveyor may guide a container to be positioned under the funnel.

It will be appreciated that the system may be used in reverse in order to remove cases from containers. The same or similar equipment may be used. It will be appreciated that the equipment may need modification to operate in reverse, in particular the guiding means may require modification.

It will be appreciated that more than one case may be positioned in a container. For example, a container may hold two substantially half-sized cases in side-by-side arrangement. The case manipulator system may be adjusted to manipulate half-sized cases, operating in a similar way to manipulating full-sized cases, shifting across by the distance of a half-sized case and repeating with a second half-sized case. Alternatively, the case manipulator system may comprise a first and second case manipulator arranged side-by-side. It will be appreciated that further urging or nudging means may be required to manipulate the two cases prior to inserting them into a container.

In the above “a container” has been considered as a carrier of cases, where cases are nested within containers. It will be appreciated, that first cases may also be nested within second cases i.e. where second cases are considered to be “containers”. For example, the case manipulator system may be used for positioning two substantially half-sized first cases within a second full-sized case. Moreover, the second full-sized case may then be positioned within a storage container, suitable for being introduced into an automated storage and retrieval system.

Other variations and advantages will become apparent from the following description.

### DESCRIPTION OF THE DRAWINGS

These and other aspects of the invention will now be described, by way of example only, and with reference to the accompanying drawings, in which:

FIG. 1 illustrates a partially opened case and a case manipulator, where the paddles of the case manipulator are inserted between the case flaps;

FIG. 2 illustrates a fully opened case and a case manipulator, where the case flaps have been folded down, parallel with the case sides, and on each side the paddles of the case manipulator are engaged with the upper folded edge of the case;

FIG. 3 illustrates the path of a pair of paddles and the sequence of movements the paddles move through during operation of the case manipulator;

FIG. 4 illustrates a detailed view of the x-direction movement mechanism of a single paddle;

FIG. 5 illustrates a detailed view of the y-direction movement mechanism of a single paddle;

FIG. 6 illustrates a detailed view of the z-direction movement mechanism of a single paddle;

FIG. 7 illustrates a detailed view of a paddle assembly having a first or x-direction pair of paddles;

FIG. 8 illustrates a detailed view of a paddle assembly having a second or y-direction pair of paddles;

FIG. 9 illustrates a view of the paddle assembly;

FIG. 10 illustrates a view of a tote or container;

FIG. 11 illustrates a case manipulator system having a first conveyor to present cases, a second conveyor to present totes or containers comprising case guides and container guides, and a case manipulator;

FIG. 12 illustrates a case manipulator system, where a case is presented to the case manipulator;

FIG. 13 illustrates a case manipulator system, where a case is gripped by the case manipulator and a container is being moved into location;

FIG. 14 illustrates a case manipulator system, where a case is within a funnel above a container;

FIG. 15 illustrates a case manipulator system, where a case is inserted in a container;

FIG. 16 illustrates a case manipulator system, where a case is inserted in a container;

FIG. 17 illustrates a case manipulator system, where a case is inserted in to a container and the case manipulator is gripping the case;

FIG. 18 illustrates an alternative case manipulator system having a first conveyor to present cases, a second conveyor to present totes or containers comprising case guides and container guides, and a case manipulator;

FIG. 19 illustrates the case manipulator of the alternative case manipulator system gripping a case;

FIG. 20 illustrates the movement of a container towards the case manipulator of the alternative case manipulator system;

FIG. 21 illustrates the placement of a case in the container using the alternative case manipulator system;

FIG. 22 illustrates detailed view of an alternative paddle assembly, having a first or x-direction pair of paddles and a second or y-direction pair of paddles;

FIG. 23 illustrates a detailed view of a paddle assembly having a bracing structure;

FIG. 24 illustrates another detailed view of a paddle assembly having a bracing structure;

FIG. 25A illustrates a perspective view of a second paddle type, shaped to fit around a corner of a case; FIG. 25B illustrates an alternative arrangement of a case manipulator, where the paddles are directed to the corners of a case;

FIG. 26A illustrates a view of a third paddle type having a pair of swivel forks and a flip spacer; FIG. 26B illustrates another view of a third paddle type having a pair of swivel forks and a flip spacer;

FIG. 27A illustrates a schematic view of a paddle assembly having a variation of the third type of paddle having a single swivel fork and a wedge gripper, wherein the swivel fork is perpendicular to the wedge gripper; FIG. 27B illustrates a schematic view of a paddle assembly having a variation of the third type of paddle having a single swivel fork and a wedge gripper, wherein the swivel fork is aligned with the wedge gripper;

FIG. 28A illustrates a fourth type of paddle or end effector having a claw end; FIG. 28B illustrates a pair of claw arms for opening the flaps of a case;

FIG. 29 illustrates an urging means for pushing a case into a central position on the conveyor;

FIG. 30 shows a case that has been delivered to a case manipulator, as part of a system for executing a sequence of movements;

FIG. 31 shows flaps being opened by a first pair of claws, as part of a system for executing a sequence of movements;

FIG. 32 shows a different type of paddle that has been positioned on the outside of the case to enable lifting and moving, as part of a system for executing a sequence of movements;

FIG. 33 shows a case that has been placed in a container, as part of a system for executing a sequence of movements;

FIG. 34 illustrates schematically the processes of combining a case and a container;

FIG. 35 illustrates a manipulator system, similar to the system shown in FIGS. 30-33;

FIG. 36 illustrates a possible arrangement of two substantially half-sized cases nested within a container; and

FIG. 37 illustrates a possible arrangement of two substantially half-sized first cases, nested within a second full-sized case, nested within a container.

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilized and structural changes may be made without departing from the scope of the invention as defined in the appended claims.

In the following description, some specific details are included to provide a thorough understanding of various disclosed embodiments. One skilled in the relevant art, however, will recognize that embodiments may be practiced without one or more of these specific details, or with other methods, arrangements, components, materials, etc. In some instances, well-known structures associated with end effectors and/or robotic manipulators, such as processors, sensors, storage devices, network interfaces, workpieces, tensile members, fasteners, electrical connectors, mixers, and the like are not shown or described in detail to avoid unnecessarily obscuring descriptions of the disclosed embodiments.

Unless the context requires otherwise, throughout the specification and the appended claims, the word “comprise” and variations thereof, such as, “comprises” and “comprising” are to be construed in an open, inclusive sense; that is, as “including, but not limited to.”

Reference throughout this specification to “one”, “an”, or “another” applied to “embodiment” or “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

Similarly, connection references (e.g., attached, coupled, connected, joined, secured, and the like) are to be construed broadly and may include intermediate members between a connection of elements and relative movement between elements. As such, connection references do not necessarily infer that those two elements are directly connected and in fixed relation to each other, unless specifically set forth in the appended claims.

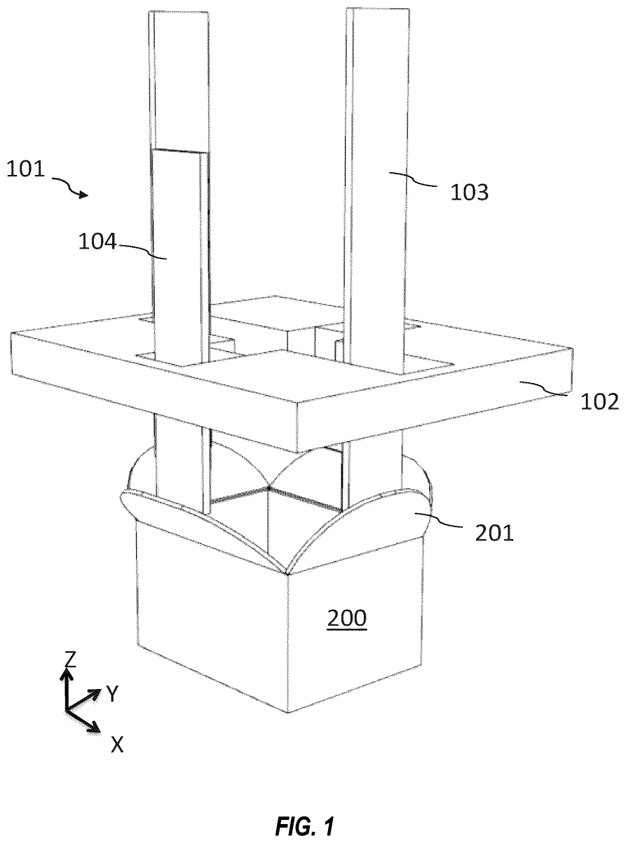

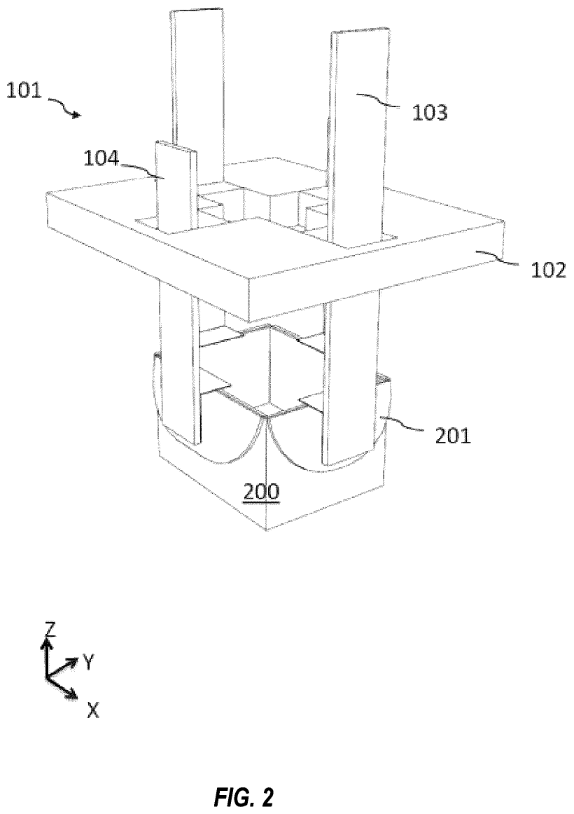

FIGS. 1 and 2 illustrate case 200 of the type described above in the background section, and a case manipulator 101 as disclosed herein.

In FIG. 1, the case is partially open with the flaps 201 upright and partially folded out, and the x-direction paddles 103 and the y-direction paddles 104 of the case manipulator are inserted between the case flaps. In FIG. 2, the case has been fully opened by the paddles of the case manipulator. As may be seen in FIG. 2, the flaps have been pushed out and over the upper edge of the case such that the upper edge is folded and the flaps are parallel with the sides of the case. As shown, the paddles are positioned with the horizontal leg of the inverted L-shape engaged with the folded edge, and the vertical part of the paddle holding the flaps against the sides of the case. The paddles are positioned substantially centrally on each side.

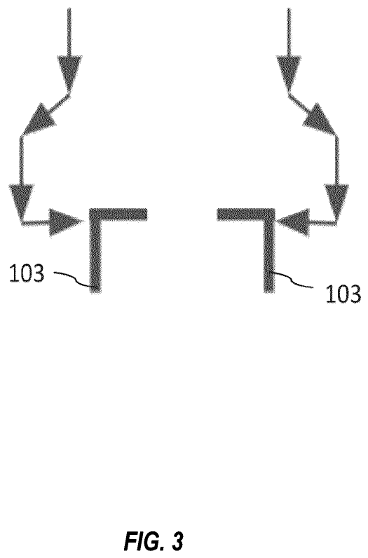

FIG. 3 illustrates the path of a pair of paddles, and the arrows show the sequence of movements each paddle moves through during operation of the case manipulator. The pathway is shaped substantially like an inverted question mark (“?”). The motion may be smoothly executed as a single movement, or the motion may comprise a series of discrete steps. In any event, it will be appreciated that the motion starts with a downward z-direction movement to position the paddles between the flaps, then an outward (x- or y-direction) and followed by a downward (z-direction) movement to push the flaps over the sides of the case. Finally, the motion may end with an inward movement to hold the flaps parallel with the sides of the case and to locate the paddles in contact with the case.

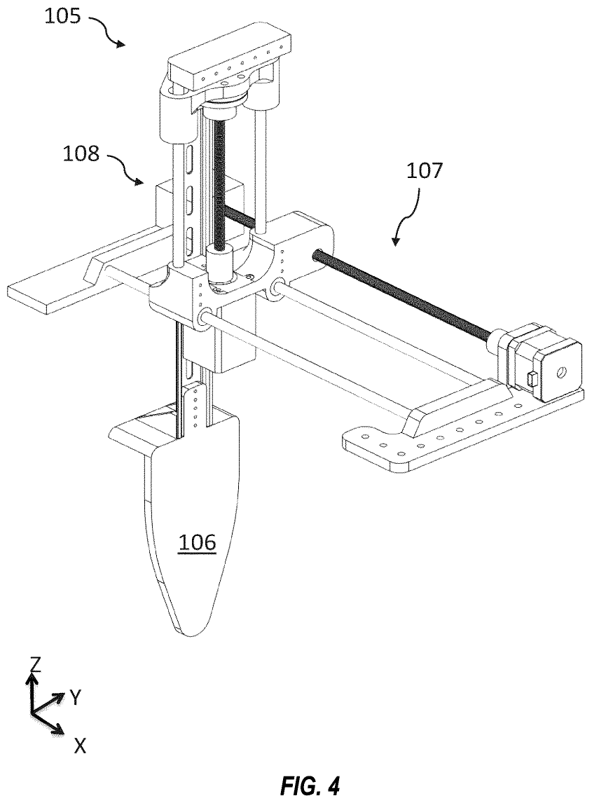

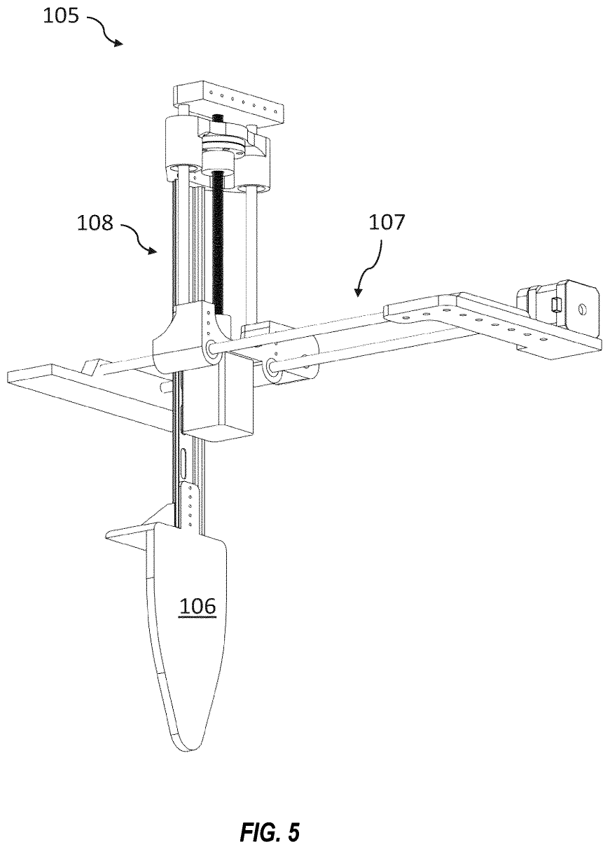

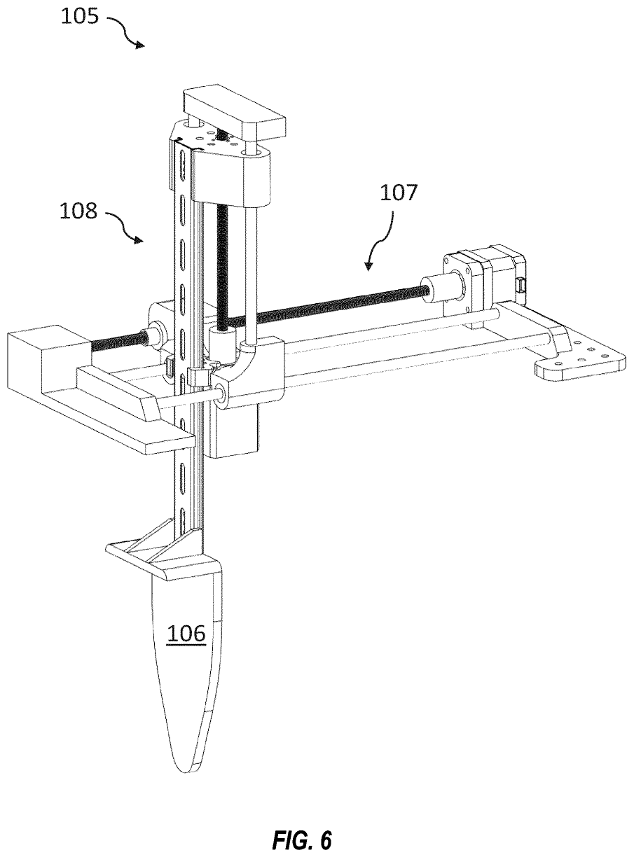

FIGS. 4-6 illustrate various views of a single paddle 105 in more detail. In particular, each paddle comprises an inverted L-shaped formation 106 for interacting with the cases. As will be apparent, the formation has a substantially horizontal part, and an elongate substantially vertical part, where the horizontal part is located closest (proximal) to the movement mechanisms. As noted elsewhere in this disclosure, the L-shaped formation may have additional features to assist in manipulating the flaps of a case, and to assist in manipulating a case as a whole.

The paddle further comprises an x- or y-respective movement mechanism 107, and the z-direction movement mechanism 108. The movement mechanism may comprise any linear movement means. In the figures these are shown as an assembly with alignment rods, and an actuating rod such as a screw rod. The screw rod is driven by a motor. Other actuating means may comprise a tooth, belt, rack and pinion, belt and pulley, a pneumatic actuator etc. The skilled person will be familiar with various actuators that would be suitable.

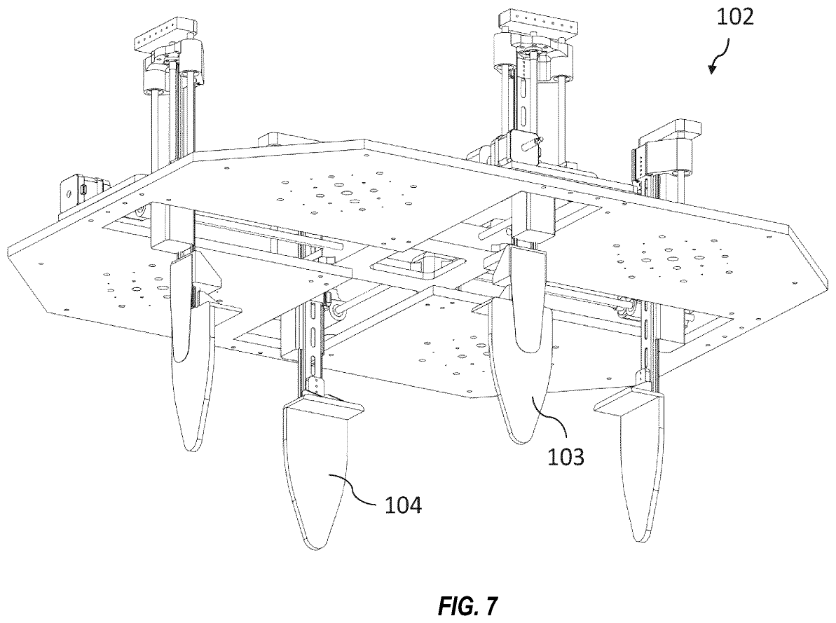

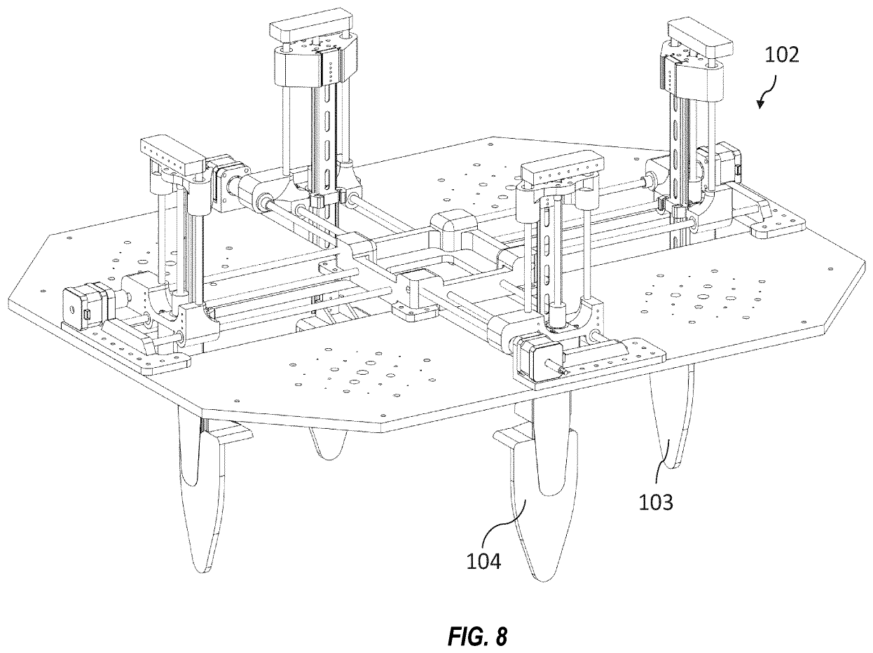

FIGS. 7-8 illustrate detailed views of a paddle assembly 102, having a first or x-direction pair of x-direction paddles 103 and a second or y-direction pair of y-direction paddles 104. Each paddle of the first and second pair of paddles may comprise a single paddle 105 as illustrated in FIGS. 4-6. As may be seen in FIGS. 7-8, the paddle assembly comprises a panel having slots, through which the x-direction paddles 103 and y-direction paddles 104 extend. The paddles of each pair of paddles are located on opposed sides, and have the horizontal part of the L-shaped formation directed to the center of the paddle assembly. The paddles are able to travel in x- or y-directions in their respective slots. The paddles are able to extend in the z-direction through their respective slots.

It will be appreciated that the parts of the paddle and the paddles assembly may be constructed from plastics, metals or any suitable materials. They may be manufactured by conventional means such as molding and machining, or 3D printing etc. The skilled person will be able to select suitable parts and method of manufacture according to the intended use of the case manipulator system.

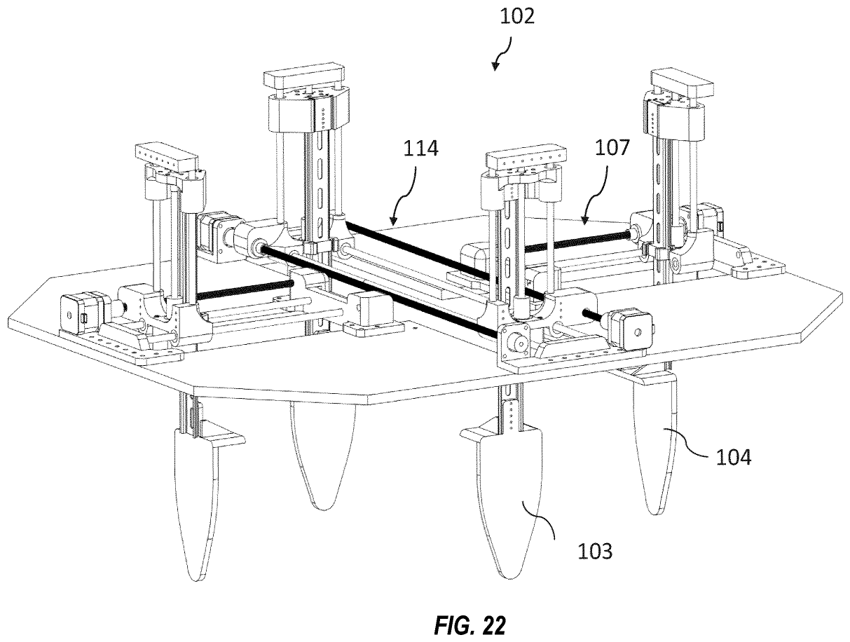

FIG. 22 illustrates an alternative type of paddle assembly 102. Similar to the paddle assembly shown in FIGS. 7-8, the paddle assembly 102 in FIG. 22 has a first or x-direction pair of x-direction paddles 103 and a second or y-direction pair of y-direction paddles 104. In this arrangement, the elongate slot for the pair of x-direction paddles 103 extends continuously across the width of the paddle assembly 102. In contrast, the elongate slot for each of the pair of y-direction paddles 104 is not continuous, and is interrupted by the x-direction slot. The y-direction paddles each comprise a single paddle 105 with respective movement mechanisms 107 as illustrated in FIGS. 4-6, whereas, the x-direction pair or paddles comprise an alternative (single) movement mechanism 114, which is shared between the pair of x-direction paddles 103 and has a dual lead screw or screw rod that drives each of the pair of x-direction paddles 103. The continuous length of lead screw between the paddles, allows the x-direction paddles 103 to have a greater range of movement, extending beyond the center of the paddle assembly 102.

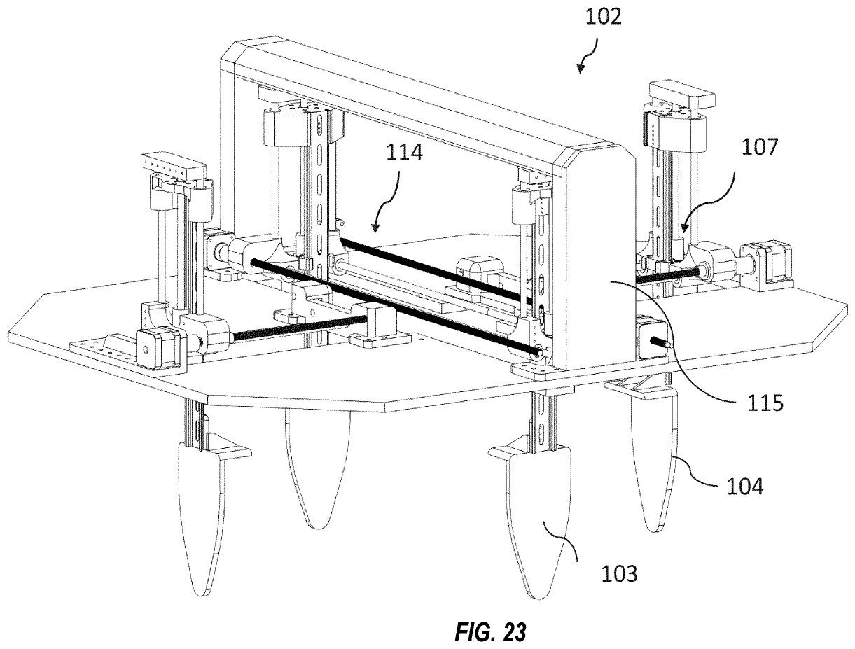

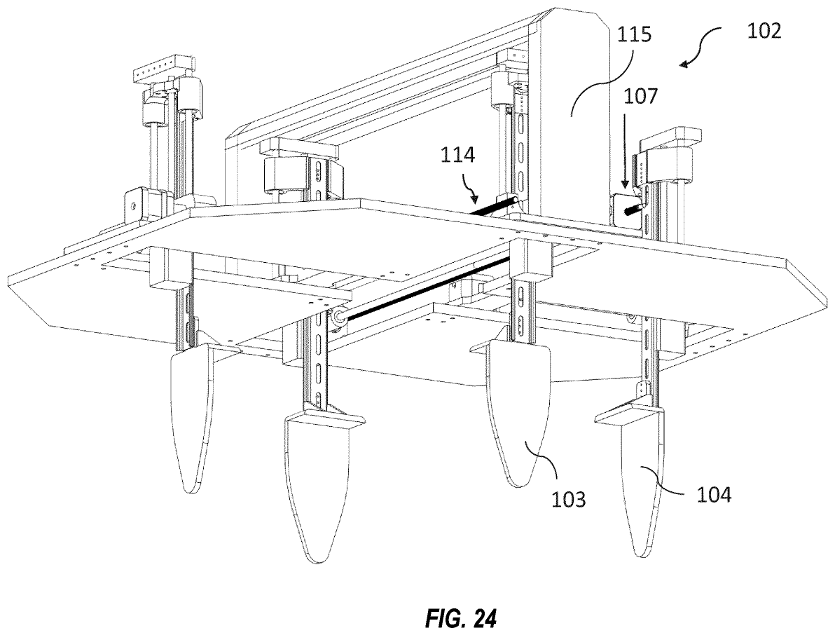

FIGS. 23-24 illustrate a further modification to the paddle assembly 102, where a brace 115 is provided over the x-direction paddles 103. The brace 115 adds rigidity to the paddle assembly 102, and stability to the x-direction paddles 103 when used to lift or grip a case.

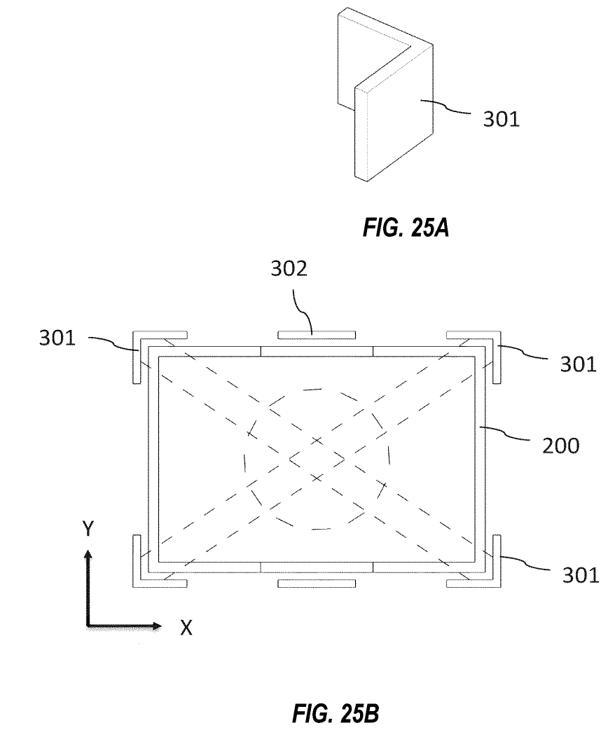

FIG. 25A illustrates a perspective view of another type of paddle 301 and arrangement where the paddles 301 are shaped to fit around a corner of a case. As illustrated in FIG. 25A the paddle 301 has a simple right-angle shape. FIG. 25B illustrates the paddles 301 directed to each of the corners of a case 200. In this figure, the diagonally extending dashed lines indicate the direction of travel of the paddles. Here the direction of travel is rotated by approximately 45° about a z-axis such that the paddles 301 are paired across diagonally opposite corners of the case 200, rather than opposing sides. Optionally, additional supports 302 may be seen along the long side of the case 200. These additional supports 302 may be part of the manipulator assembly to help center the case 200.

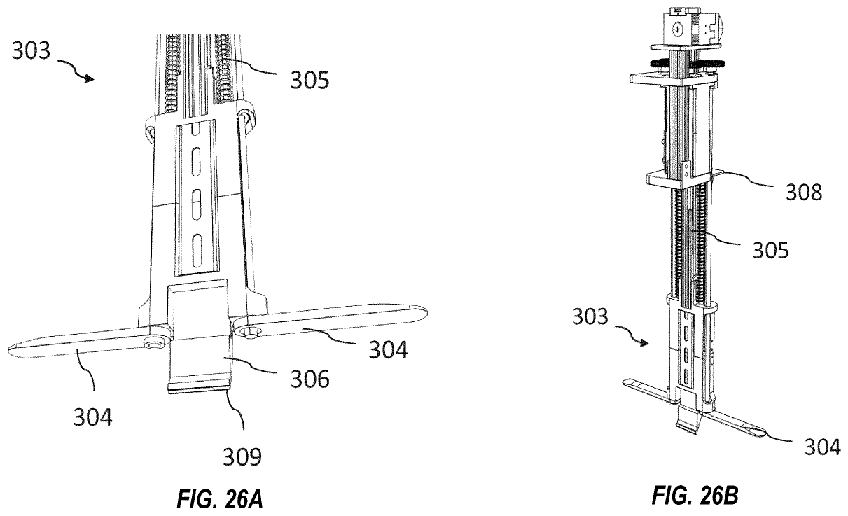

FIGS. 26A-26B illustrate views of a third type of paddle, a y-side paddle 303. The y-side paddle 303 is shown at the distal end of a z-direction movement mechanism 305 and is intended for use on a side of a case (not shown). At the distal end of the paddle itself, there is a pair of swivel forks 304, in the configuration where the swivel forks 304 are arranged such that they would be parallel with the side of a case. It will be appreciated that in other embodiments, the third type of paddle, the y-side paddle 303, may have only a single swivel fork rather than a pair.

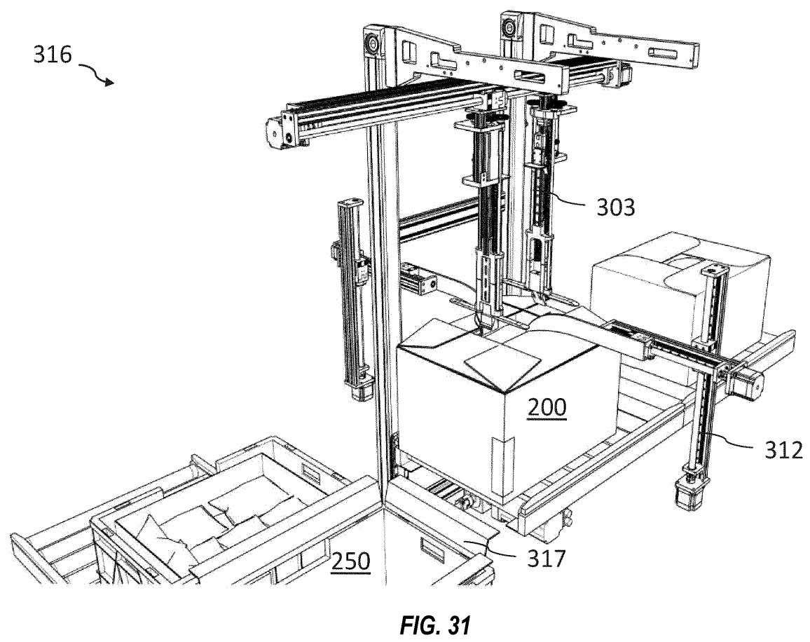

In addition, at the distal end of the paddle, between the pair of swivel forks 304 is a wedge 306. As explained and shown below in respect of FIG. 31, the wedge can be used to open a flap of a fan flap case. As shown, the wedge 306 extends beyond the level of the swivel forks 304 in a first position. The wedge 306 is biased in this first position, typically with a spring. The wedge 306 may be pushed to a second position where wedge 306 is retracted into the arm and the lip 309 is substantially level with the swivel forks 304.

A top plate 308 of the paddle may be used to locate at the top edge of a case, as indicated in more detail below.

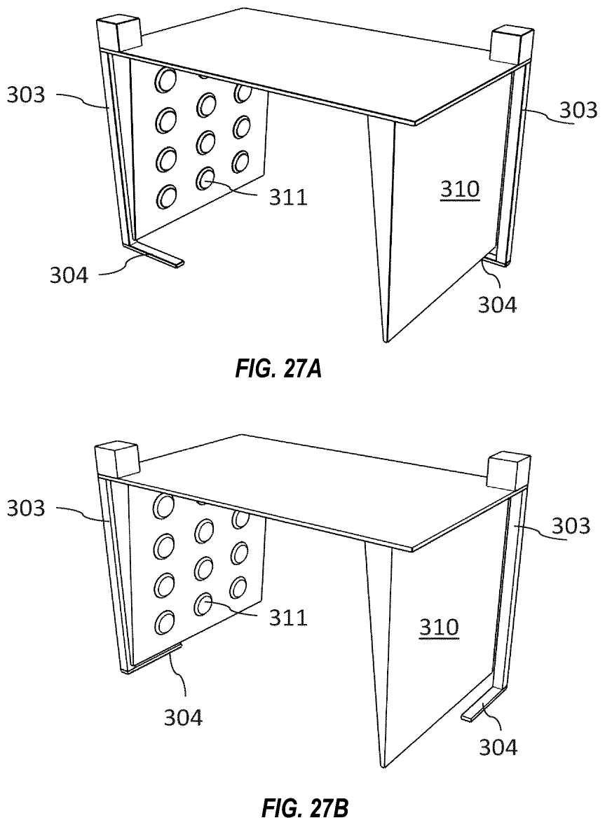

FIGS. 27A-27B illustrate a schematic view of a paddle assembly having a variation of the third type of paddle, the y-side paddle 303. In FIGS. 27A-27B, a pair of y-side paddles 303 are connected together and each has a single swivel fork 304, a wedge gripper 310. In FIG. 27A the swivel forks 304 are perpendicular to the wedge gripper 310 and in FIG. 27B the swivel forks 304 are aligned with the wedge gripper 310. The wedge gripper 310 comprises suction cups 311 to assist in holding a case. Alternatively, a high surface fiction or other features may be used on the inside surface of the wedge grippers 310. The use of swivel forks 304 ensure that a case is supported from the bottom, whilst the wedge grippers ensure the case is also supported from the side. Hence, the handling of the case is improved.

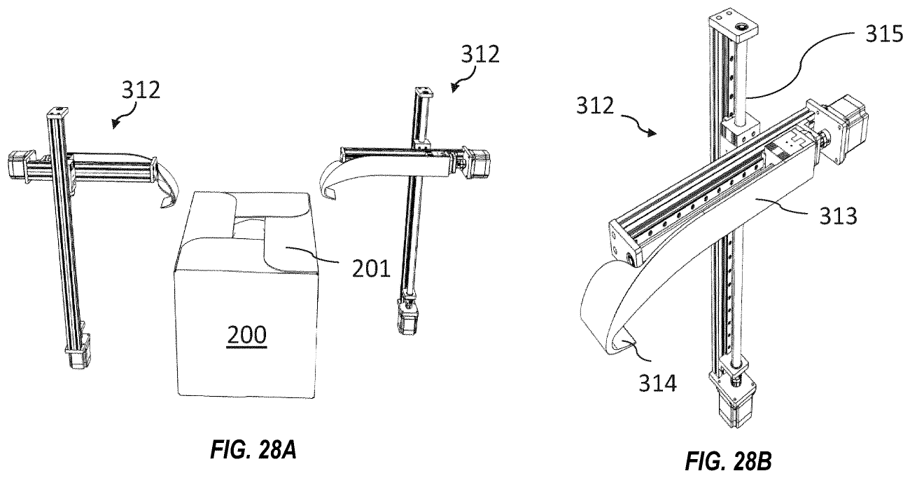

A fourth type of paddle, an x-side paddle 312 is illustrated in FIGS. 28A-28B. As can be seen in FIG. 28B the paddle 312 has a claw end 314 at the end on arm 313. The arm 313 may extend in an x- or y-direction, and is mounted on a vertical movement mechanism 315. FIG. 28A illustrates a pair of x-side paddles 312 together with a case 200.

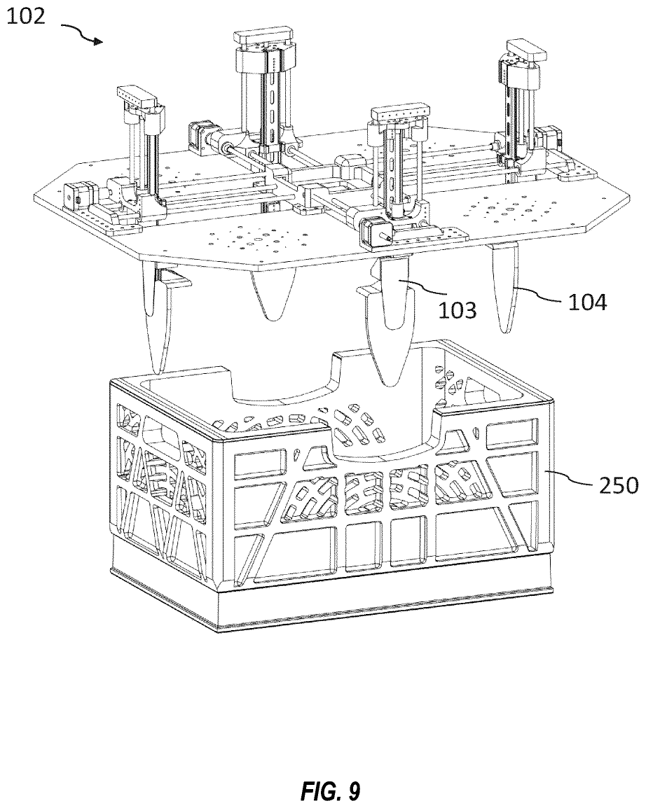

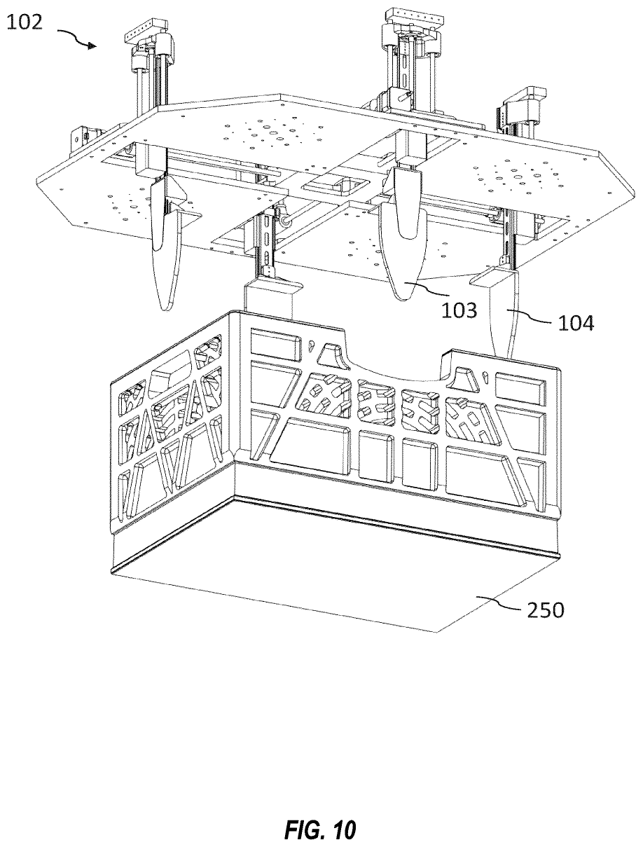

FIGS. 9-10 illustrate views of the paddle assembly and a tote or container. As shown in FIGS. 9 and 10, the x-direction paddles 103 and y-direction paddles 104 align with the inside of the tote or container. This ensures that the case can be precisely placed within the tote or container.

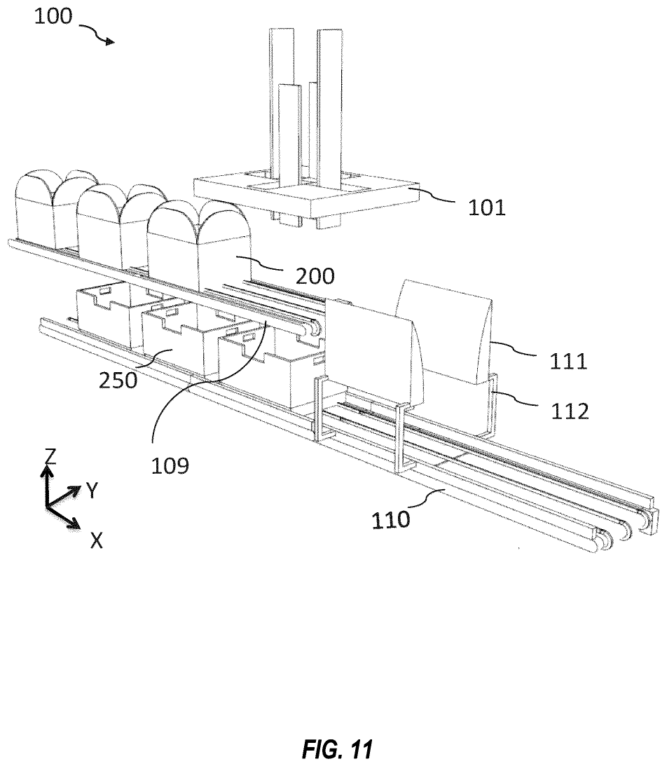

FIG. 11 illustrates an overview of a case manipulator system, and FIGS. 11-16 illustrate substantially the sequence of actions for manipulating a case and moving the case from a first location to a second location in a container, or removing a case from a container.

As illustrated in FIG. 11, a first conveyor 109 for presenting cases 200 is located above a second conveyor 110 for presenting containers or totes 250. The second conveyor extends beyond the limit of the first conveyor, such that both the first conveyor and the second conveyor are accessible by the case manipulator located above the conveyors. The case manipulator is able to move linearly between two positions, a first position above the first location at the end of the first conveyor, sized for a case to occupy (empty as shown in FIG. 11) and a second position above the second location on the second conveyor where a tote may be located. The conveyors are used to present cases and totes to the case manipulator as they are needed. Although the second conveyor is shown as parallel to the first conveyor, it will be appreciated the conveyers may not be parallel to one another.

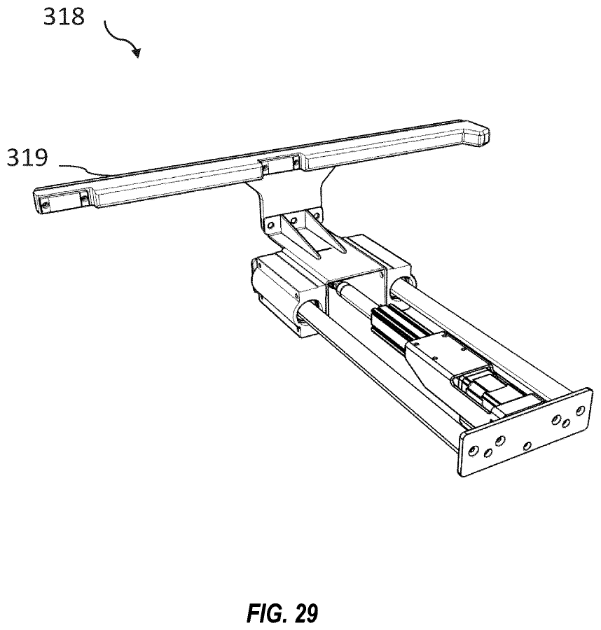

FIG. 29 illustrates an urging means 318 for pushing a case into a central position on the conveyor. When a case is positioned adjacent to the bar 319, the mechanism is activated to push the case against a stop and hold the case in position.

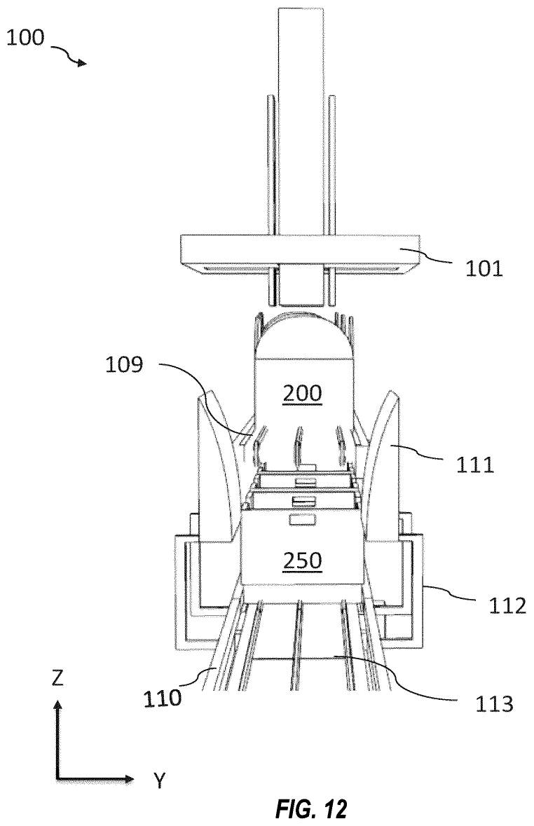

FIG. 12 is an end view of the case manipulator system where a case is positioned at the end of the first conveyor directly under the case manipulator. As may be seen in the figure, the first and second pairs are paddles are positioned so that they may be lowered between the flaps of the case. Accordingly, the case manipulator may fold the flaps over the sides of the case, as described above.

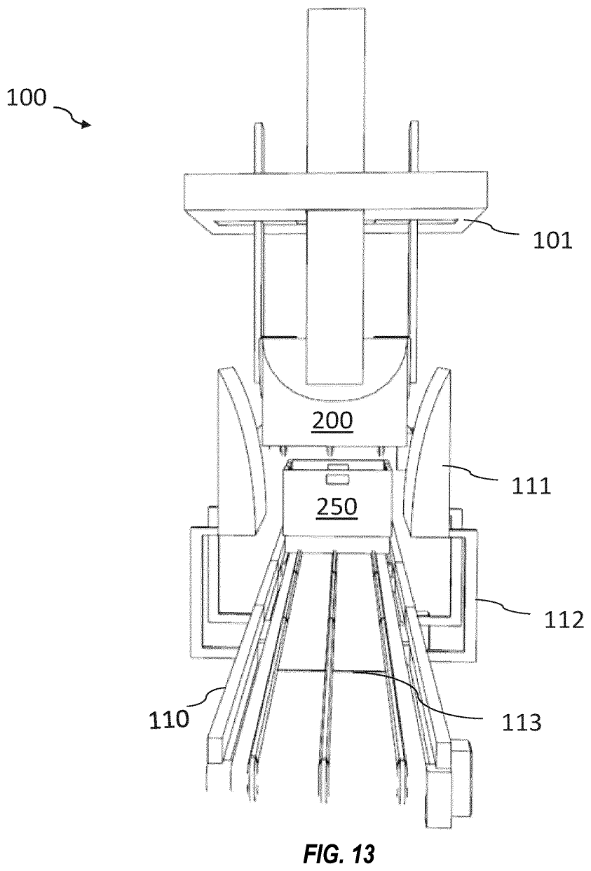

FIG. 13 is again an end view of the case manipulator system. As may be seen in FIG. 13, the flaps of the case have been folded down, and the case is gripped by the two pairs of paddles. The pairs of paddles have been lifted such that the case has been lifted from the first conveyor. Furthermore, the case manipulator has begun to move the case to be positioned within the funnel 111. The funnel comprises first and second halves, positioned on each side of the second conveyor.

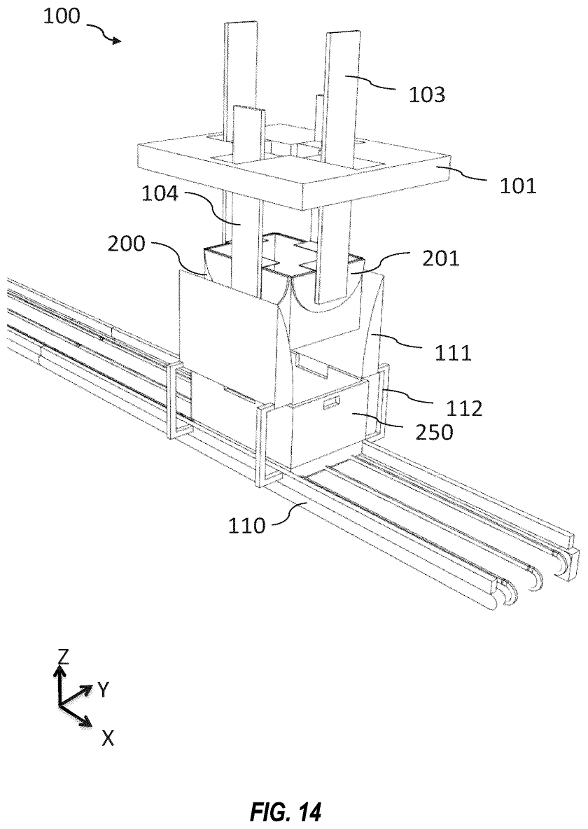

FIG. 14 shows a detail of the second conveyor, the funnel and the case manipulator in use. The case manipulator is gripping a case, as shown in FIG. 13. In FIG. 14, a tote has been moved into position under the funnel. The guides 112 ensure that the tote is correctly positioned in the y-direction, and the guide 113 (indicated in FIGS. 12-13) ensures that the tote is correctly positioned in the z-direction. The case is positioned between the funnel, which helps to center the case and guide the case into the tote.

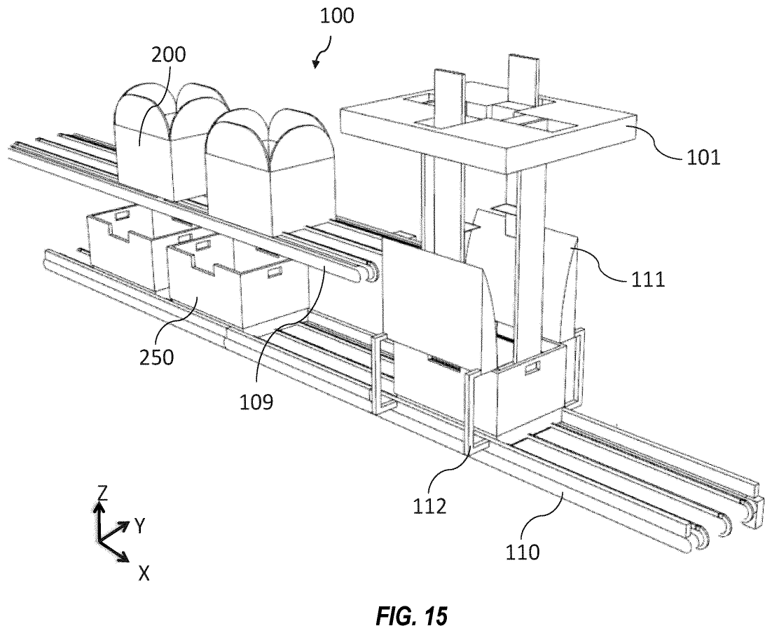

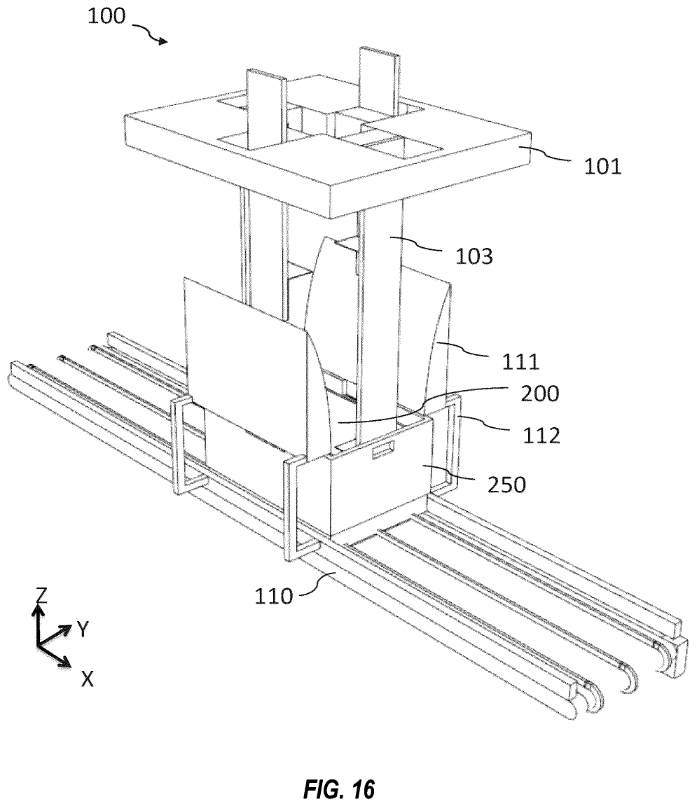

FIG. 15 shows a wider view for the manipulator system and FIG. 16 shows the second conveyor, the funnel and the case manipulator in more detail. In FIG. 15, the case is no longer held by the second pair of paddles, as these would not fit through the funnel. Instead, the funnel continues to hold the flaps down, and squeezes the longer sides of the case together. Due to the relative dimensions between the cases and the funnel, the first pair of paddles are used to push the case through the funnel into the tote below. The first pair of paddles continue to push the case until the case is fully inserted into the tote. In this example, the dimension of the tote and case allow for the case to be positioned within the tote while the first pair of paddles are still engaged with the case. Finally, the paddles can be removed from the case and the tote, and the second conveyor may move on the combined tote and inserted case.

The case manipulator system may then reset ready to combine the next case and tote.

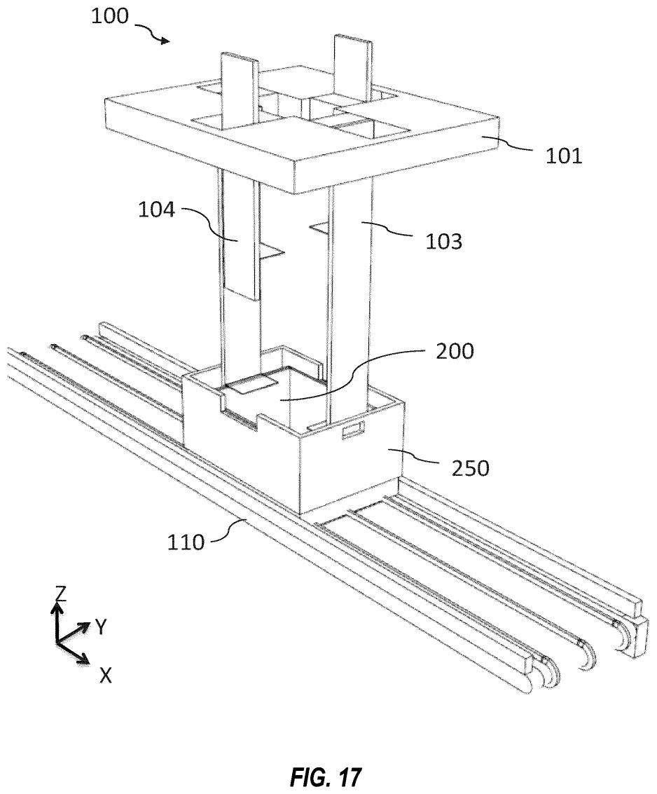

FIG. 17 shows the case manipulator interacting with a combined tote and case in an alternative location where the funnel is not present.

The arrangement shown in FIG. 17 may be at a location where totes and cases are separated. In such a location, a first pair of paddles are used to extend into the combined tote and case, between the outer edge of the tote and the inner edge of the tote. Paddles may then be controlled to grip the case and lift the case from the tote.

Alternatively, the arrangement shown in FIG. 17 may be an alternative arrangement for combining cases and totes, for example, where the relative dimensions of the cases and totes are such that there is enough space that alignment of the case and tote is not as critical. In this alternative situation, the funnel may be unnecessary for inserting the case into the tote.

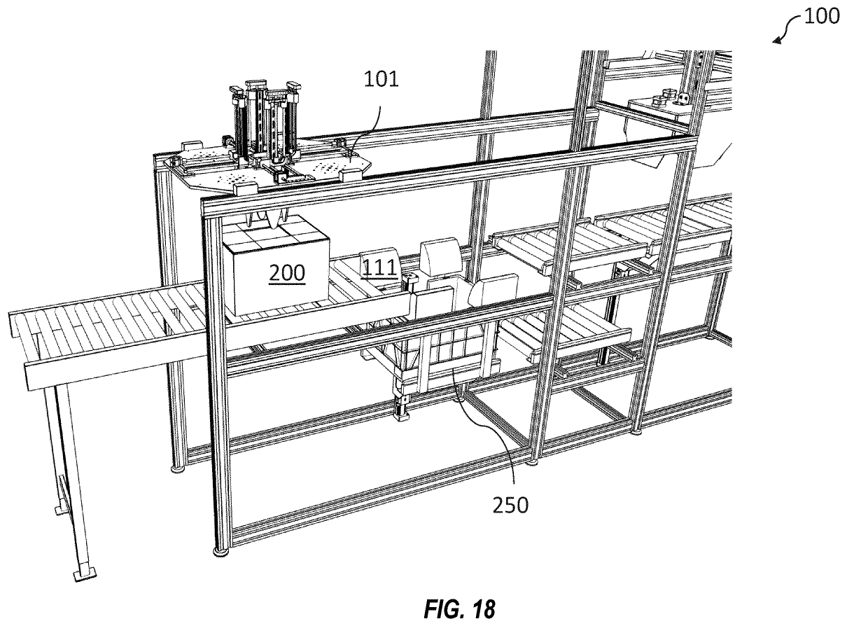

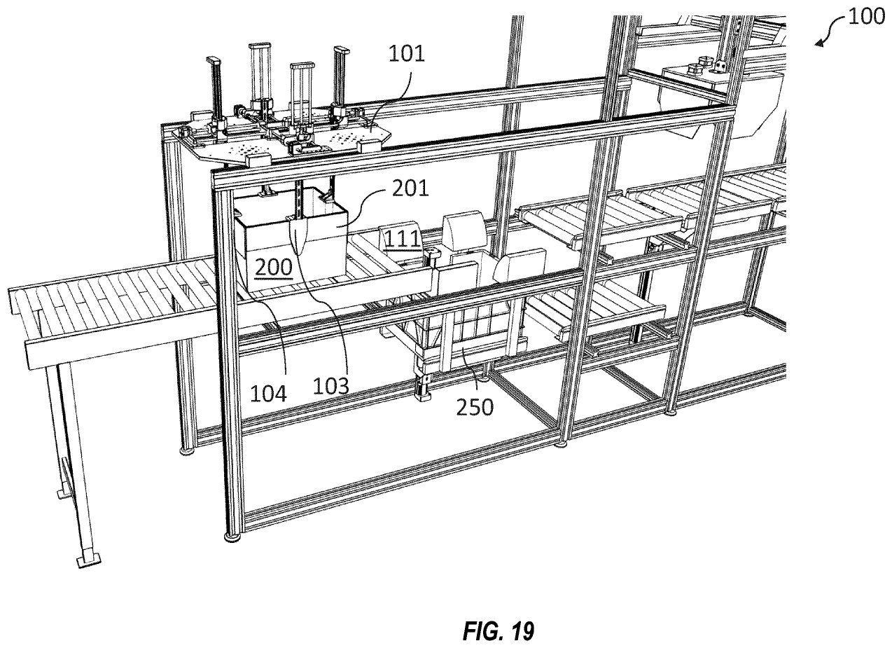

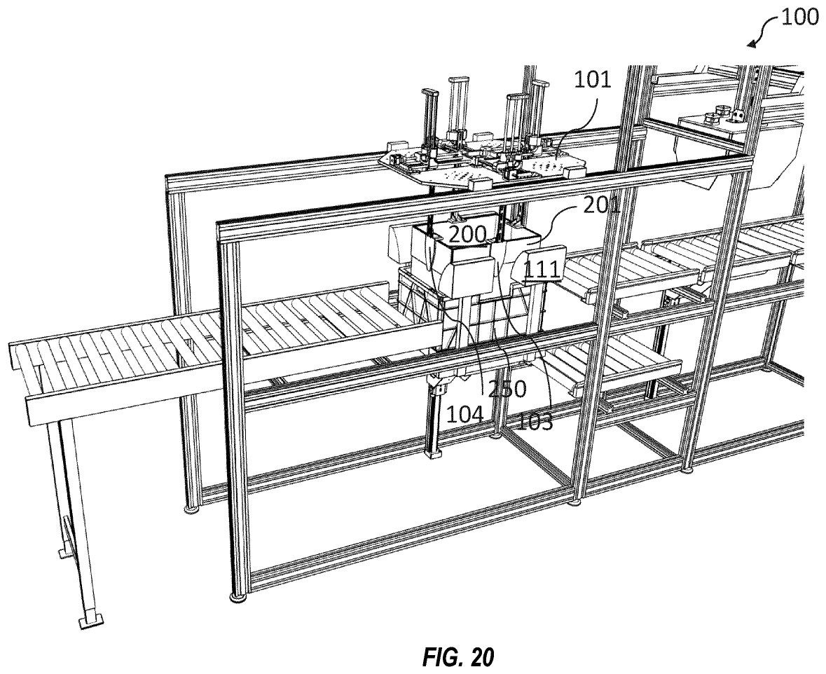

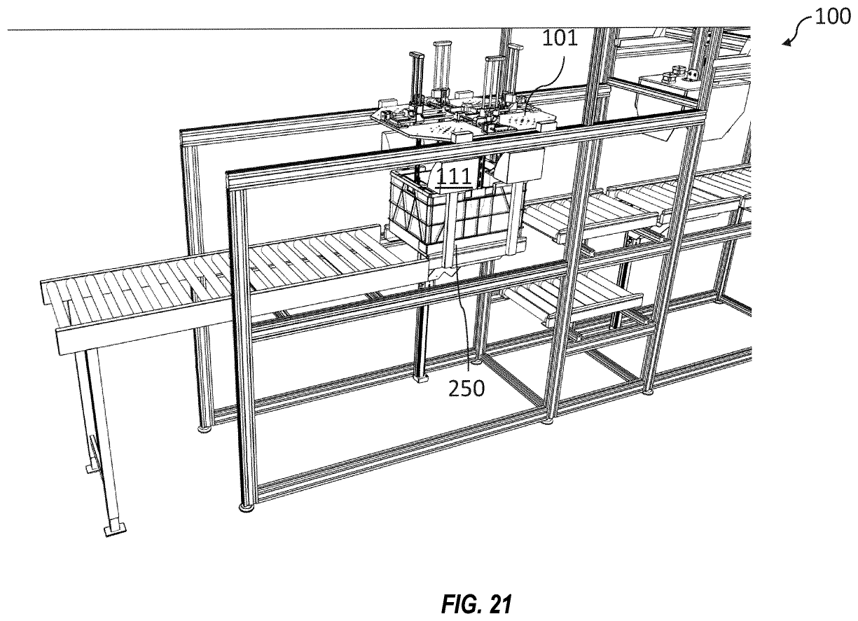

FIGS. 18-21 illustrate a second arrangement of a case manipulator system, and having similar features as the arrangement disclosed in connection with FIGS. 1-17. In order, FIGS. 18-21 show the sequence of movements of the case manipulator system 100. In this arrangement, rather than the case 200 being pushed down between the funnel 111, when the case is located between the funnel, a section of the second or lower conveyor of the second location is raised with a container 250 in place. This action, with the case held in place by the x-direction paddles 103 and y-direction paddles 104 forces the case into the tote. The combined tote and case may then be moved on at the level of the first or upper conveyor, or the movable section of conveyor may be lowered and the combined tote and case may be moved on at the lower level.

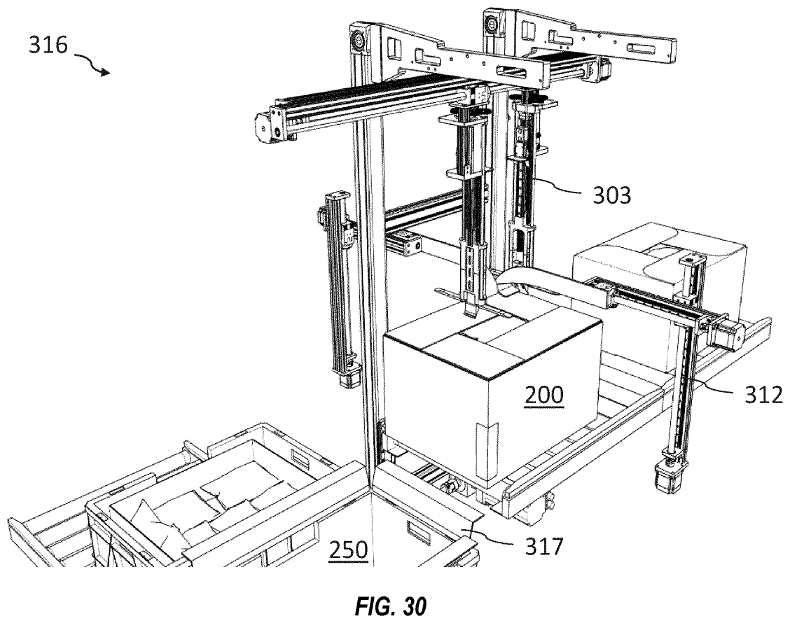

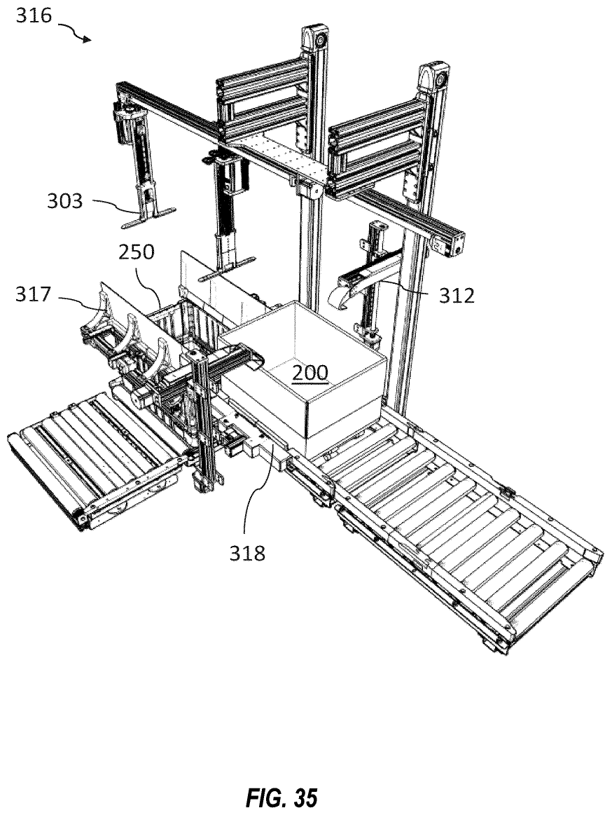

FIGS. 30-33 illustrate a case manipulator system 316 in use, and FIG. 35 illustrates the case manipulator system 316 with a variation of the guiding means 317. The case manipulator system 316 comprises a pair of y-side (or x-side) paddles 303, a pair of x-side (or y-side) paddles 312.

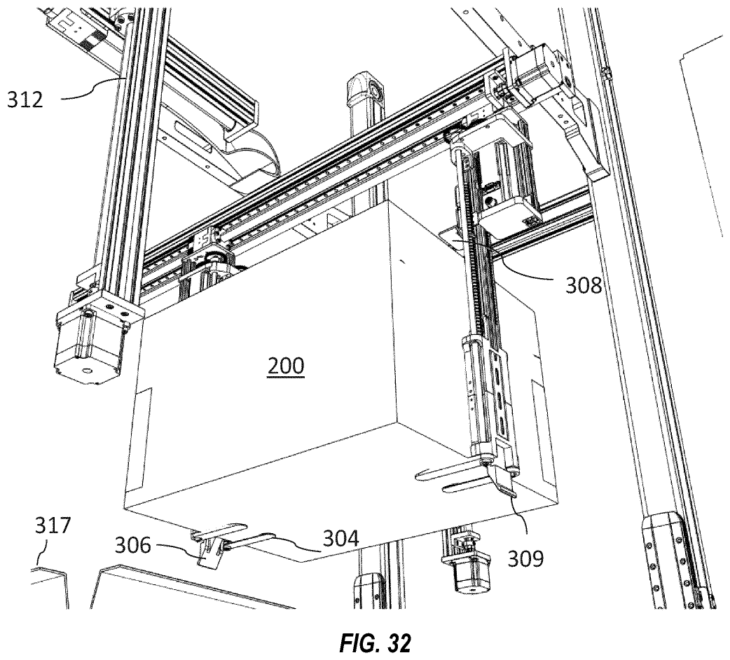

In FIG. 30 a case 200 has been delivered to the case manipulator system 316 by the conveyor. It will be appreciated that an urging means 318 (FIG. 35) can be used with the case manipulator system to hold the case in place. In FIG. 31 the pair of x-side paddles 312 and the pair of y-side paddles 303 are inserted between the case folds. The urging means 318 (FIG. 35) is used to hold the case 200 in position while the claws of the x-side paddles 312 are used to open the case flaps. First, the x-side paddles 312 are used to pull open the x-side flaps, and then the y-side paddles 303 are the used to open and fold the y-side flaps, lip 309 (best seen in FIG. 32) at the distal end of the wedge 306 is used to assist in opening the y-side flaps.

Once the flaps have been folded down parallel with the side of the case, the y-side paddles 303 are extended down and the swivel forks 304 are rotated such that the case may be supported on the swivel forks 304 and lifted, as shown in FIG. 32.

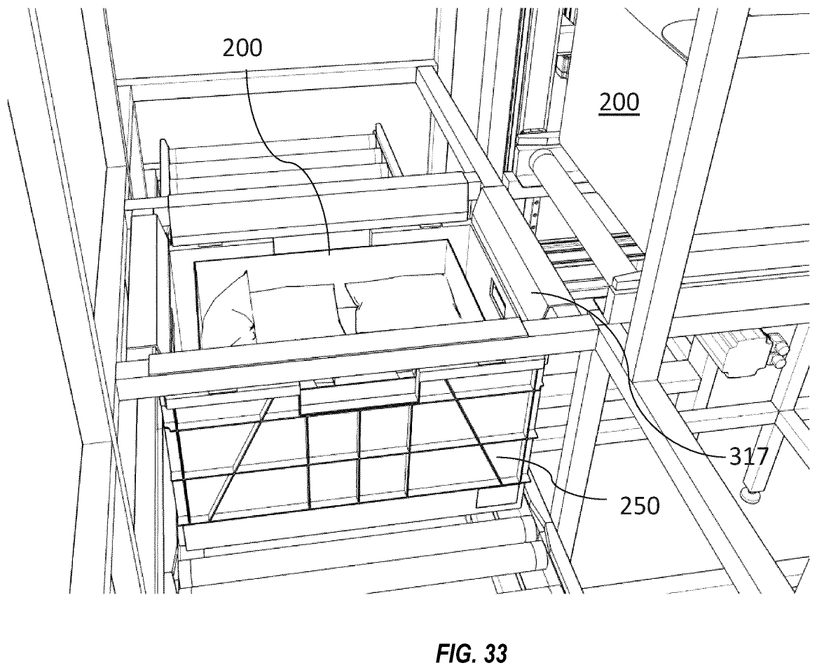

The case is then moved across by the case manipulator system 316 to above the empty container 250 pushed into the container through the guiding means 317, FIG. 33.

In FIG. 35, the case 200 is shown with the flaps already folded down. The x-side paddles 312 are positioned above the case 200, and the y-side paddles 303 are positioned above the container 250. From the view in FIG. 35, it will be appreciated how the x-side paddles are movable between a position above where the case 200 is shown to a position above where the container 250 is located.

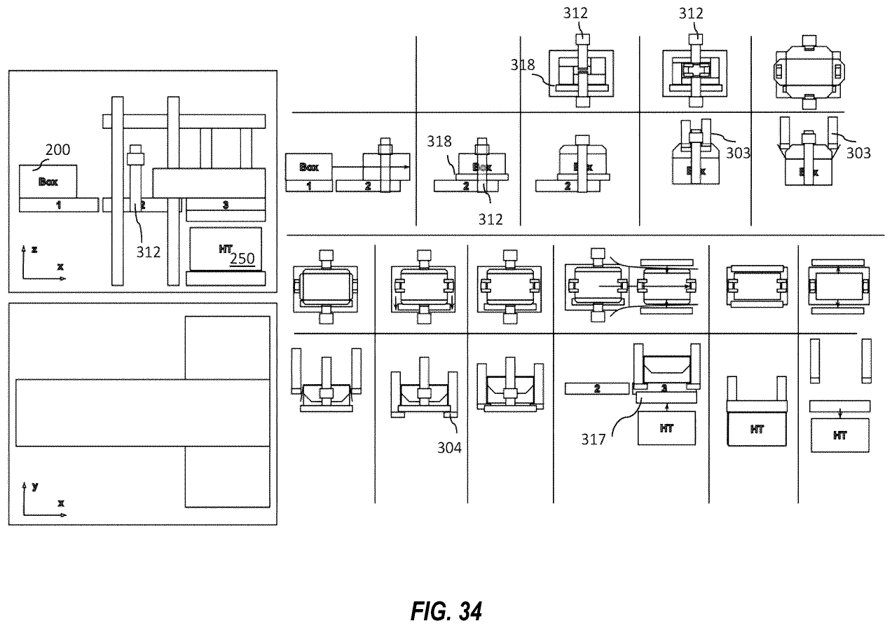

FIG. 34 illustrates schematically the sequence of the process of combining a case and a container. The left-hand side of the diagram shows plan views of the case manipulator system 316, where a case 200 (box) moves in sequence from 1-2-3. The right-hand side, similarly shows plane views, with the y-x plane above the z-x plane, and the sequence shown across the two rows from left to right (. As can be seen the case is moved into position 2 where it is between x-side paddles 312, and centralized with the urging means 318. First the x-side paddles 312 are used to open the case, and fold the x flaps, and then the y-side paddles 303 are used to fold the y flaps. The y-side paddles 303 are extended down below the bottom of the case. The swivel forks 304 are rotated to support the case. The case is then lifted to position 3 where it is lowered through guiding means 317 into the container 250.

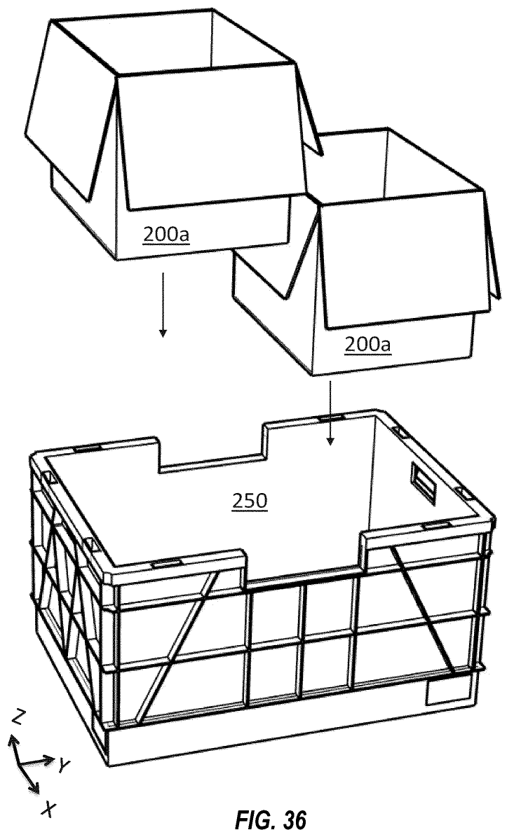

FIG. 36 illustrates a possible arrangement of two substantially half-sized cases 200a nested within a container 250. As illustrated the half-sized cases 200a are proportioned such that they may be arranged side-by-side within the container 250. In the illustrated example, the half-sized cases 200a are open, with their flaps folded down such that the contents of the half-sized cases 200a are accessible from above the container 250. It will be appreciated, similar closed half-sized cases in side-by-side arrangement could be nested in the container 250 for storage or sortation purposes, for example.

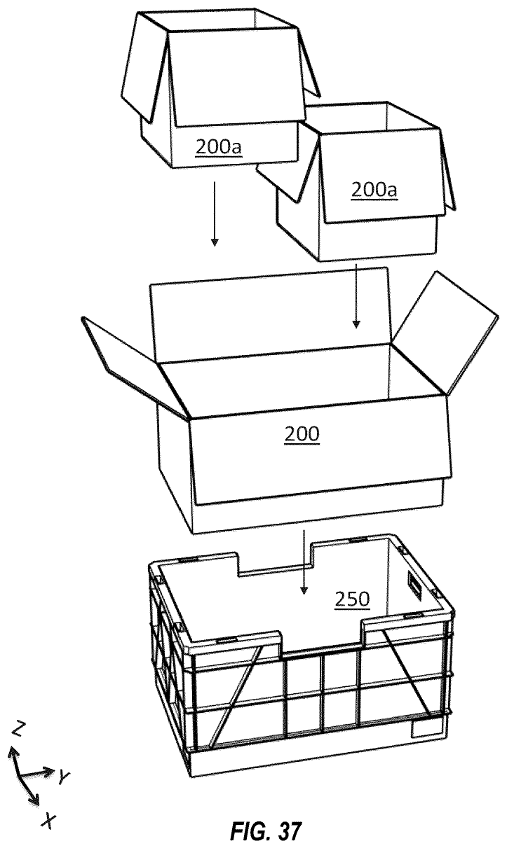

FIG. 37 illustrates another possible arrangement of two substantially half-sized cases 200a, nested within a second full-sized case 200, nested within a container 250. In the illustrated example, each of the half-sized cases 200a and full-sized case 200 are open, with their flaps folded down such that the contents of the two half-sized cases 200a are accessible from above the container 250. It will be appreciated that any of the half-sized cases 200a or full-sized case 200 may be closed if it is not required that the contents are accessible.

It will be appreciated that variations of the case manipulator system as disclosed herein, and additional well-known optional features would enable arrangements such as those illustrated in FIGS. 36-37. Further, other combinations and arrangements of cases are conceivable, depending on the required use. It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

Whilst endeavoring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A method of moving a case from a first location to a second location, the method comprising:
when a case manipulator is in a first position, controlling a paddle assembly to lower a first pair of paddles such that the first pair of paddles is positioned between a pair of case flaps;
moving the first pair of paddles, the moving the first pair of paddles comprising:
engaging with the pair of case flaps outwardly in an x-direction;
pushing or pulling the pair of case flaps inwardly in the x-direction;
folding the pair of case flaps over and downwardly in a z-direction on an outside of the case;
positioning a second pair of paddles at opposing folded top edges of the case by moving the second pair of paddles downwardly in the z-direction, or positioning the second pair of paddles at opposing sides of the case by moving the second pair of paddles inwardly in the x-direction; and
clamping the case between the first pair of paddles or the second pair of paddles inwardly in the x-direction;
moving a movable support from the first location to the second location;
positioning the case within a guiding means at the second location;
releasing the case; and
inserting the case into a container at the second location,
wherein performing the controlling, moving, moving positioning, releasing, and inserting steps in reverse order removes the case from the container at the second location and places the case at the first location.

2. The method of moving a case from a first location to a second location of claim 1, wherein at least one of the controlling, moving, moving positioning, releasing, and inserting are performed in a y-direction and the z-direction by the second pair of paddles to engage with each side of the case.

3. The method of moving a case from a first location to a second location of claim 1, wherein after the positioning the case within the guiding means at the second location and before the releasing the case, at least one of the first or second pair of paddles is used to move the case vertically.

4. The method of moving a case from a first location to a second location of claim 1, further comprising a first step of using a first conveyor to present the case to or receive the case from the case manipulator.

5. The method of moving a case from a first location to a second location of claim 4, further comprising a first step of using a second conveyor to move the container to be positioned under the guiding means.

6. A case manipulator system for use in an automated storage and retrieval system and for carrying out the method of claim 1, the case manipulator system comprising:
a first location for one or more cases;
a second location, wherein the second location comprises a guiding means for guiding the one or more cases into or out of a container; and
a case manipulator comprising:
a moveable support, the movable support configured to move from a first position above the first location to a second position above the second location; and
a paddle assembly comprising at least a first pair of paddles, the paddle assembly arranged to move the at least first pair of paddles relative to the moveable support horizontally in an x-direction and vertically in a z-direction, wherein:
the case manipulator is arranged such that the case in the first location is accessible by the case manipulator, the case manipulator system controllable to engage with the case and move the case from the first location to the second location, the case manipulator system controllable to insert the case into the container at the second location, or
the case manipulator system is arranged such that the case in the container at the second location is accessible by a box manipulator, the case manipulator controllable to remove the case from the container and place the case at the first location.

7. The case manipulator system of claim 6, wherein the case manipulator is controllable to:
engage with and fold one or more case flaps; or
grip opposing sides of the case to lift the case.

8. The case manipulator system of claim 6, wherein the second location comprises a second conveyor operable to present a container under the guiding means.

9. The case manipulator system of claim 6 the paddle assembly further comprising a second pair of paddles, wherein:
the paddle assembly is configured to move the second pair of paddles horizontally in a y-direction and vertically in the z-direction;
the first pair of paddles and the second pair of paddles are independently operable; or
each paddle of the first pair of paddles and each paddle of the second pair of paddles is independently operable.

10. The case manipulator system of claim 6, wherein the second location comprises one or more guides for guiding containers into a position in the second location.

11. The case manipulator system of claim 6, wherein:
the guiding means is a stationary funnel; or
the guiding means is a retractable locator.

12. The case manipulator system of claim 6, wherein:
each paddle of the first pair of paddles has an inverted L-shape;
one or more paddle of the first pair of paddles comprises a hooked distal end; or
one or more paddle of the first pair of paddles comprises a gripping means.

13. The case manipulator system of claim 6, further comprising a control utility.

14. The case manipulator system of claim 6, wherein the first location comprises a first conveyor operable to present the case to the case manipulator.

15. The case manipulator of claim 14, wherein the first conveyor comprises an indexing means to ensure that a plurality of cases are sufficiently spaced to open and fold down case flaps.
